(19) United States
(12) Patent Application Publication
(10) Pub. No.: US 2025/0168685 A1
(43) Pub. Date: May 22, 2025

(54) PASSIVE SENSING IN WIRELESS COMMUNICATIONS

(71) Applicant: Lenovo (Singapore) Pte. Limited, Singapore (SG)

(72) Inventors: Seyedomid Taghizadeh Motlagh, Oberursel (DE); Ali Ramadan Ali, Kraiburg (DE); Vijay Nangia, Woodridge, IL (US)

(73) Assignee: Lenovo (Singapore) Pte. Limited, Singapore (SG)

(21) Appl. No.: 18/948,026

(22) Filed: Nov. 14, 2024

Related U.S. Application Data
(60) Provisional application No. 63/600,536, filed on Nov. 17, 2023.

(51) Int. Cl. H04W 24/10

(52) U.S. Cl. CPC H04W 24/10

(57) ABSTRACT

Various aspects of the present disclosure relate to passive sensing in wireless communications. An apparatus (e.g., a user equipment (UE), a network entity (NE)) receives measurement configuration for performing a passive sensing measurement, performs a passive sensing measurement based at least in part on the received measurement configuration, and transmits information pertaining to the passive sensing measurement.

### RELATED APPLICATION

This application claims priority to U.S. Provisional Application Ser. No. 63/600,536 filed Nov. 17, 2023 entitled “PASSIVE SENSING IN WIRELESS COMMUNICATIONS,” the disclosure of which is incorporated by reference herein in its entirety.

### TECHNICAL FIELD

The present disclosure relates to wireless communications, and more specifically to passive sensing in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include to receive measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and perform a passive sensing measurement based at least in part on the received measurement configuration.

In some implementations of the method and apparatuses described herein, the sensing signal is indicated to illuminate a sensing target area of interest; receive reporting configuration for reporting the passive sensing measurement; and transmit a report of the passive sensing measurement and according to the reporting configuration; at least one of the one or more second parameters or the one or more third parameters include one or more of: at least one of an indication of one or more propagation paths of the wireless channel that are one or more of received by the first apparatus or transmitted by the first apparatus, the at least one indication of the one or more paths including one or more of a path, a path identifier, a path description, a previously detected path, a previously reported path, or a previously tracked path; at least one of an object indicated to the first apparatus via an object identifier (ID), the object is one or more of previously defined for the first apparatus detected, reported by the first apparatus, tracked by the first apparatus, or measured by the first apparatus; at least one of an indication of a quasi-co-location (QCL) type-D relation, a transmit beam identifier, or a receive beam identifier of the first apparatus among the one or more paths; or relative to one or more of an antenna or an antenna array of the first apparatus, at least one of an indication of a beam angular description, an illumination area description, an angle, an area index, a relative angle, or a relative area index.

In some implementations of the method and apparatuses described herein, the path description includes one or more values for one or more of azimuth, elevation of arrival, elevation of departure, propagation path delay, or doppler shift; the object is indicated to the first apparatus by indicating one or more of object type, object radar cross section (RCS), object position, object area, or object velocity; measurements by the first apparatus include one or more of measurements of path power, delay, angle, or doppler shift associated to the first apparatus; the at least one processor is configured to cause the first apparatus to determine the sensing beam based at least in part on one or more of information available at the first apparatus or information that can be obtained by the first apparatus within an indicated time delay; the at least one processor is configured to cause the first apparatus to indicate, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application; the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing.

In some implementations of the method and apparatuses described herein, one or more of determine or transmit a preference of one or more of the sensing signal descriptions for performing passive sensing measurements; and perform, based at least in part on the preference of the one or more of the sensing signal descriptions, the passive sensing measurements based at least in part on reception of a transmission as a preferred signal; indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the first apparatus; the known computational artificial intelligence machine learning models include one or more of: one or more artificial intelligence machine learning models transferred to the first apparatus for sensing measurements; or one or more artificial intelligence machine learning models available at the first apparatus and indicated by the first apparatus to a sensing configuration entity for the passive sensing measurements; receive an artificial intelligence machine learning model training configuration.

In some implementations of the method and apparatuses described herein, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receive first state information on a state of one or more objects; receive the sensing signal according to the received training configuration; and perform training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus; the at least one processor is configured to cause the first apparatus to obtain state information on the one or more objects or paths.

In some implementations of the method and apparatuses described herein, the at least one processor is configured to cause the first apparatus to autonomously obtain state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the first apparatus to obtain the state information, the at least one processor is configured to cause the first apparatus to indicate to the network one or more of a type of the obtained information, an accuracy of the obtained information, or a resolution of the obtained information; a type of the obtained information includes an information source; the at least one processor is configured to cause the first apparatus to report, to a network entity, a status of the computational artificial intelligence machine learning model, the status includes one or more of, based at least in part on application of the computational artificial intelligence machine learning model, an accuracy of the passive sensing measurement, an error level of the passive sensing measurement, or a request for retraining of the computational artificial intelligence machine learning model.

In some implementations of the method and apparatuses described herein, the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receive a suitability query including suitability criteria for performing the passive sensing measurement, the suitability criteria including one or more of: a location area for passive sensing measurement one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria.

In some implementations of the method and apparatuses described herein, the at least one processor is configured to cause the first apparatus to receive the suitability query via one or more of a broadcast message, a multicast message, dedicated signaling in a connected state, a paging message with a group radio network temporary identifier (RNTI) associated with sensing, or a paging RNTI with a first apparatus identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receive a first set of one or more downlink beams including a suitability query for performing the passive sensing measurement; and receive a second set of one or more downlink beams for performing the passive sensing measurement.

Some implementations of the method and apparatuses described herein may further include receiving measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and performing a passive sensing measurement based at least in part on the received measurement configuration.

In some implementations of the method and apparatuses described herein, the sensing signal is indicated to illuminate a sensing target area of interest; receiving reporting configuration for reporting the passive sensing measurement; and transmitting a report of the passive sensing measurement and according to the reporting configuration; at least one of the one or more second parameters or the one or more third parameters include one or more of: at least one of an indication of one or more propagation paths of the wireless channel that are one or more of received by the UE or transmitted by the UE, the at least one indication of the one or more paths including one or more of a path, a path identifier, a path description, a previously detected path, a previously reported path, or a previously tracked path; at least one of an object indicated to the UE via an object ID, the object is one or more of previously defined for the UE detected, reported by the UE, tracked by the UE, or measured by the UE; at least one of an indication of a QCL type-D relation, a transmit beam identifier, or a receive beam identifier of the UE among the one or more paths; or relative to one or more of an antenna or an antenna array of the UE, at least one of an indication of a beam angular description, an illumination area description, an angle, an area index, a relative angle, or a relative area index.

In some implementations of the method and apparatuses described herein, the path description includes one or more values for one or more of azimuth, elevation of arrival, elevation of departure, propagation path delay, or doppler shift; the object is indicated to the first apparatus by indicating one or more of object type, object RCS, object position, object area, or object velocity; measurements by the first apparatus include one or more of measurements of path power, delay, angle, or doppler shift associated to the first apparatus; determining the sensing beam based at least in part on one or more of information available at the first apparatus or information that can be obtained by the first apparatus within an indicated time delay; indicating, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application.

In some implementations of the method and apparatuses described herein, the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing; one or more of determining or transmitting a preference of one or more of the sensing signal descriptions for performing passive sensing measurements; and performing, based at least in part on the preference of the one or more of the sensing signal descriptions, the passive sensing measurements based at least in part on reception of a transmission as a preferred signal; indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the first apparatus.

In some implementations of the method and apparatuses described herein, the known computational artificial intelligence machine learning models include one or more of: one or more artificial intelligence machine learning models transferred to the UE for sensing measurements; or one or more artificial intelligence machine learning models available at the UE and indicated by the UE to a sensing configuration entity for the passive sensing measurements; receiving an artificial intelligence machine learning model training configuration, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receiving first state information on a state of one or more objects; receiving the sensing signal according to the received training configuration; and performing training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus; obtaining state information on the one or more objects or paths.

In some implementations of the method and apparatuses described herein, autonomously obtaining state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the UE to obtain the state information, the method further includes indicating to the network one or more of a type of the obtained information, an accuracy of the obtained information, or a resolution of the obtained information; a type of the obtained information includes an information source; reporting, to a network entity, a status of the computational artificial intelligence machine learning model.

In some implementations of the method and apparatuses described herein, the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receiving a suitability query including suitability criteria for performing the passive sensing measurement, the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmitting a response to the received suitability criteria.

Some implementations of the method and apparatuses described herein include receiving the suitability query via one or more of a broadcast message, a multicast message, dedicated signaling in a connected state, a paging message with a group RNTI associated with sensing, or a paging RNTI with a UE identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receiving a first set of one or more downlink beams including a suitability query for performing the passive sensing measurement; and receiving a second set of one or more downlink beams for performing the passive sensing measurement.

Some implementations of the method and apparatuses described herein may further include to receive a request for a sensing task associated with an area of interest for sensing; transmit, to a second apparatus, a message including a suitability query for a passive sensing measurement of the area of interest for sensing; receive a response including a suitability indication for performing passive sensing measurements of the area of interest for sensing; and transmit, to the second apparatus, measurement configuration for performing passive sensing measurements of the area of interest.

Some implementations of the method and apparatuses described herein include to receive reports of the passive sensing measurements from the second apparatus; compute sensing results associated to the received sensing tasks; and transmit the sensing results to the requester of the sensing task; the first apparatus includes a network entity and the second apparatus includes a user equipment (first apparatus); the first apparatus includes a first user equipment (first apparatus) and the second apparatus includes a second first apparatus; the at least one processor is configured to cause the first apparatus determine information including at least one of one or more transmissions of physical data, one or more transmissions of control signals, or one or more transmissions of reference signals illuminating the area of interest for sensing; the at least one processor is configured to cause the first apparatus to determine the information via communication with a RAN node and via sensing a query and response toward a gNB assigned for a sensing task; the at least one processor is configured to cause the first apparatus to transmit the message including the suitability query via one or more of a broadcast message or a groupcast message; the suitability query includes one or more of: passive sensing configuration; a capability description for a passive sensing user equipment (first apparatus); a maximum distance to the area of interest for sensing; an accuracy value for a passive sensing measurement; or an availability indication for a line of sight condition at the second apparatus; transmit a first set of one or more downlink beams including the suitability query; and transmit a second set of one or more downlink beams for performing the passive sensing measurement.

Some implementations of the method and apparatuses described herein may further include receiving a request for a sensing task associated with an area of interest for sensing; transmitting, to a second apparatus, a message including a suitability query for a passive sensing measurement of the area of interest for sensing; receiving a response including a suitability indication for performing passive sensing measurements of the area of interest for sensing; and transmitting, to the second apparatus, measurement configuration for performing passive sensing measurements of the area of interest.

Some implementations of the method and apparatuses described herein include receiving reports of the passive sensing measurements from the second apparatus; computing the sensing results associated to the received sensing tasks; and transmitting the obtained sensing results to the requester of the sensing task; the first apparatus includes a network entity and the second apparatus includes a user equipment (UE); the first apparatus includes a first user equipment (UE) and the second apparatus includes a second UE; determining information including at least one of one or more transmissions of physical data, one or more transmissions of control signals, or one or more transmissions of reference signals illuminating the area of interest for sensing; determining the information via communication with a RAN node and via sensing a query and response toward a gNB assigned for a sensing task; transmitting the message including the suitability query via one or more of a broadcast message or a groupcast message; the suitability query includes one or more of: passive sensing configuration; a capability description for a passive sensing user equipment (UE); a maximum distance to the area of interest for sensing; an accuracy value for a passive sensing measurement; or an availability indication for a line of sight condition at the second apparatus; transmitting a first set of one or more downlink beams including the suitability query; and transmitting a second set of one or more downlink beams for performing the passive sensing measurement.

Some implementations of the method and apparatuses described herein may further include to transmit measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receive a passive sensing measurement based at least in part on the received measurement configuration.

In some implementations of the method and apparatuses described herein, the at least one processor is configured to cause the first apparatus to transmit the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmit a query to the RAN node; and receive a response from the RAN node indicating one or more of the first availability information or the second availability information; the at least one processor is configured to cause the first apparatus to request that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level; an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space.

In some implementations of the method and apparatuses described herein, the indication that the transmission direction of the signal transmission is aligned includes one or more of an angular azimuth or an elevation difference; transmit a request for additional information for one or more signal transmission parameters; and transmit a request message for transmission of a message decodable via a RNTI which is sharable with one or more user equipment (first apparatus) capable of performing sensing measurements, the request message including one or more of suitability criteria or description of first apparatus for performing a passive sensing measurement; the request for additional information includes a request for one or more of more accurate time resources or more accurate frequency resources for signal transmission.

Some implementations of the method and apparatuses described herein may further include transmitting measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receiving a passive sensing measurement based at least in part on the received measurement configuration.

Some implementations of the method and apparatuses described herein include transmitting the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmitting a query to the RAN node; and receiving a response from the RAN node indicating one or more of the first availability information or the second availability information; requesting that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level.

In some implementations of the method and apparatuses described herein, an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space; the indication that the transmission direction of the signal transmission is aligned includes one or more of an angular azimuth or an elevation difference; transmitting a request for additional information for one or more signal transmission parameters; and transmitting a request message for transmission of a message decodable via a RNTI which is sharable with one or more user equipment (UE) capable of performing sensing measurements, the request message including one or more of suitability criteria or description of UE for performing a passive sensing measurement; the request for additional information includes a request for one or more of more accurate time resources or more accurate frequency resources for signal transmission.

### BRIEF DESCRIPTION OF THE DRAWINGS

FIG. 1 illustrates an example of a wireless communications system in accordance with aspects of the present disclosure.

FIG. 2 illustrates an example of a UE performing passive sensing measurements on an unknown signal via different methods for passive sensing measurements, including directional power measurements or correlation-based measurements.

FIG. 3 illustrates an example of a UE performing passive sensing measurements on an unknown signal via different methods for passive sensing measurements where a leakage compensation stage among the two signals is performed prior to the measurements.

FIG. 4 illustrates example scenarios 400 for radio sensing that supports passive radio sensing measurements in accordance with aspects of the present disclosure.

FIG. 5 illustrates example scenarios 500 for radio sensing that supports passive radio sensing measurements in accordance with aspects of the present disclosure.

FIG. 6 illustrates a scenario 600 for a tight coupling integrated sensing and communication (ISAC) network architecture.

FIG. 7 illustrates a scenario 700 for a tight coupling ISAC network architecture.

FIG. 8 illustrates a scenario 800 where a sensing function (SF) is collocated with the LMF.

FIG. 9 illustrates a scenario 900 for loose coupling ISAC network architecture.

FIG. 10 illustrates an example of a procedure 1000 in accordance with aspects of the present disclosure.

FIG. 11 illustrates an example of a procedure 1100 in accordance with aspects of the present disclosure.

FIG. 12 illustrates an example of a UE 1200 in accordance with aspects of the present disclosure.

FIG. 13 illustrates an example of a processor 1300 in accordance with aspects of the present disclosure.

FIG. 14 illustrates an example of a network element (NE) 1400 in accordance with aspects of the present disclosure.

FIG. 15 illustrates a flowchart of a method 1500 in accordance with aspects of the present disclosure.

FIG. 16 illustrates a flowchart of a method 1600 in accordance with aspects of the present disclosure.

FIG. 17 illustrates a flowchart of a method 1700 in accordance with aspects of the present disclosure.

### DETAILED DESCRIPTION

Radio sensing has been discussed in the context of cellular wireless networks, both as a mechanism to improve the network performance as well as an enabler to serve vertical use-cases. In particular, radio sensing can obtain environment information by the means of (i) transmission of a sensing signal (e.g., a sensing reference signal (RS), from a network or UE entity, hereafter termed as sensing Tx node, (ii) reception of the reflections/echoes of the transmitted sensing excitation signal from the environment by a network or a UE entity, hereafter termed as sensing Rx node, (iii) processing of the received reflections and inferring relevant information from the environment, etc.

Apart from approaches based on coherent knowledge of the transmitted sensing signal (e.g., performing sensing measurements based on transmission and reception of an RS where the transmitted RS is known at the sensing Rx node), a sensing Rx node may further utilize the received signals from any transmission source for the purpose of sensing measurement, such as where the transmitted signal is not known to the sensing Rx node. Examples are when received signals of the NR downlink (DL) physical downlink shared channel (PDSCH) or physical downlink control channel (PDCCH) channel (prior to the decoding of the contained/encoded data) is utilized for the purpose of sensing of the environment. Some proposals have discussed the possibility of relying on directional power estimation and correlation-based methods for the purpose of passive sensing at a UE device with the assistance of the network is explored, where presence of a sensing target and/or ranging of a sensing target can be facilitated via the proposed power measurements and/or the correlation methods. Nevertheless, in many instances, the proposed correlation and/or power measurements may fail to deliver reliable sensing information due to factors such as the inherent inaccuracy of relying on data channels unknown to the passive sensing device, natural fluctuations of the observed angular power due to the device rotation, distance to the transmission source, leads to unreliable detection/sensing based on measured angular power, and imperfect correlation property of the data channels, which may lead to large cross-correlation of a reference signal with a delayed version of the reference signal.

Accordingly, aspects of the disclosure are directed to solutions for passive sensing measurement of a UE device which can be configured by the network, such as in the context of obtaining sensing information by the network. For instance, the described implementations enable indication of a reference beam, sensing beam, and function computed jointly on the received signal of the two beams; L1 measurement of cross correlation at different taps, different harmonic shifts, or combination thereof based on signal with unknown modulated sequence and unknown information content, which can include indication of leakage compensation of the signal received via the reference beam to the signal received via the sensing beam; determination by a sensMF for configuring passive sensing measurements, at least in part, based on the availability of data channels illuminating the desired sensing area, which can include a query & response on the availability of signal transmission towards the desired direction/area from associated RAN nodes; training of an artificial intelligence (AI) model for passive sensing measurement based on the DL physical data/control channels such as via broadcasting or multicasting (among the UEs capable of performing passive sensing) of a true sensing feature (presence/position of a target) measurable at the passive sensing UEs; indication of a Tx/Rx beam via one or more of indication of a path, indication of a relative angle difference, indication of a distance, etc.; and enabling a UE to request assisting information from a sensMF for availability and description of the signal transmissions illuminating an area of interest for sensing.

According to implementations a passive sensing operation may be interpreted as a sensing operation where sensing measurements are performed, at least in part, over a non-reference signal, e.g., a signal for which embedded and/or modulated data (e.g., modulated symbols or data bit sequence), information, and/or an embedded sequence is not known and is not intended to be obtained at a measurement node. However, implementations described in this disclosure are not limited to this interpretation, and it is to be understood that they may be equally applicable for any sensing operation and/or measurement utilizing known reference signals.

Thus, the described solutions can enable more accurate passive sensing such as for identifying objects and attributes of objects in an environment.

Aspects of the present disclosure are described in the context of a wireless communications system.

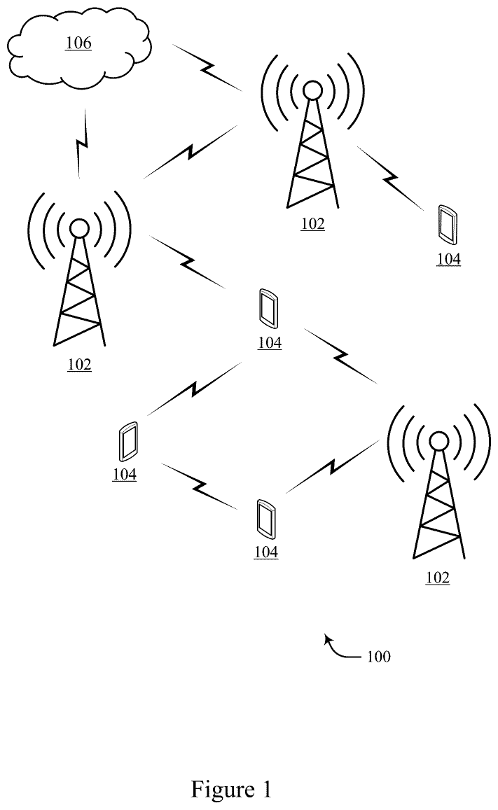

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 can be configured by a NE 102 to gather passive sensing measurements and transmit the passive sensing measurements to a NE 102. The NE 102 can utilize the passive sensing measurements to determine attributes of an environment around the UE 104, such as for detecting physical objects in proximity to the UE 104.

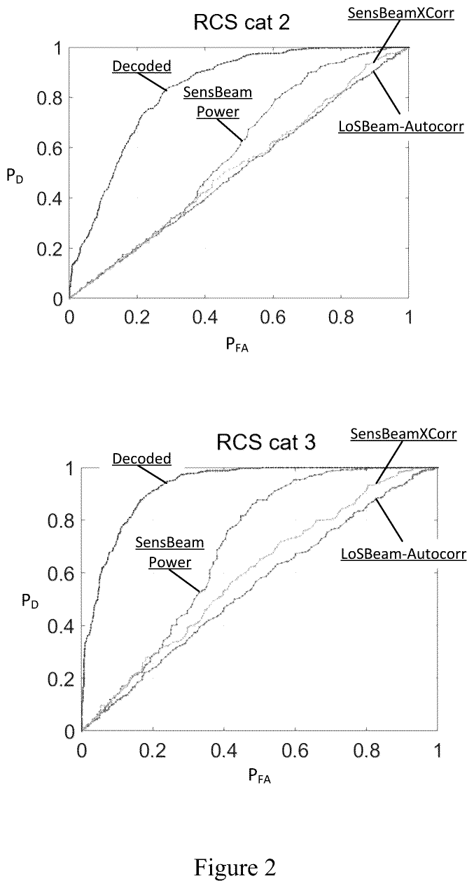

FIG. 2 illustrates an example of a UE performing passive sensing measurements on an unknown signal via different methods for passive sensing measurements, including directional power measurements or correlation-based measurements. FIG. 2, for instance, illustrates an example performance evaluation for a UE performing power or correlation measurements.

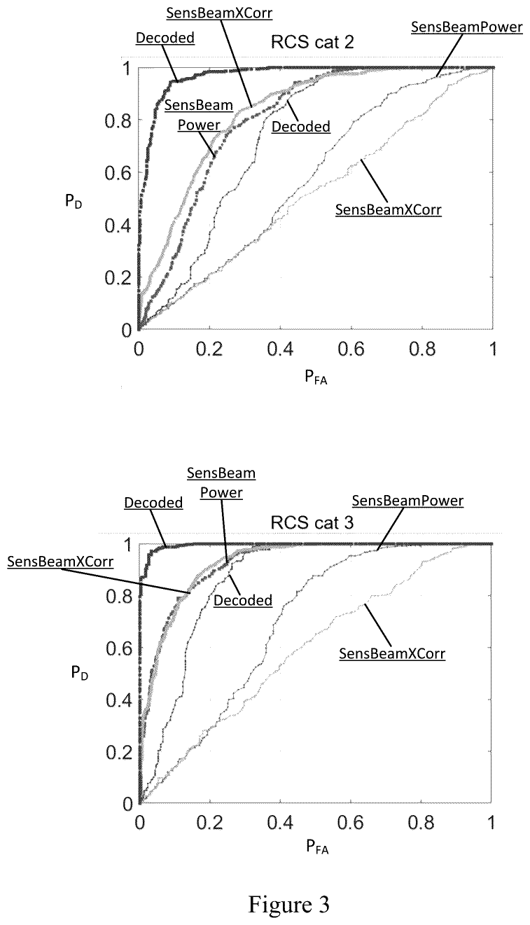

FIG. 3 illustrates an example of a UE performing passive sensing measurements on an unknown signal via different methods for passive sensing measurements where a leakage compensation stage among the two signals is performed prior to the measurements. FIG. 3, for instance, illustrates an example for adjustment when passive sensing measurements are performed over two different received signals via separate beams, and the received sensing signals are compensated for a first-tap leakage prior to measurements, such as to reduce the impact for imperfect self-correlation.

With reference to the radio sensing scenarios described for passive radio sensing measurements, network-based and UE-based (sidelink-based) radio sensing operations include proposed solutions to cover scenarios of radio sensing, where the network configures the participating sensing entities (i.e., network and UE nodes performing as sensing Tx nodes, network and UE nodes performing as sensing Rx nodes, as well as the configuration of sensing RS and necessary measurements and reporting procedures from the nodes). In this regard, the functional split between the network and the UE nodes for a specific sensing task may take various forms, depending on the availability of sensing-capable devices and the requirements of the specific sensing operation.

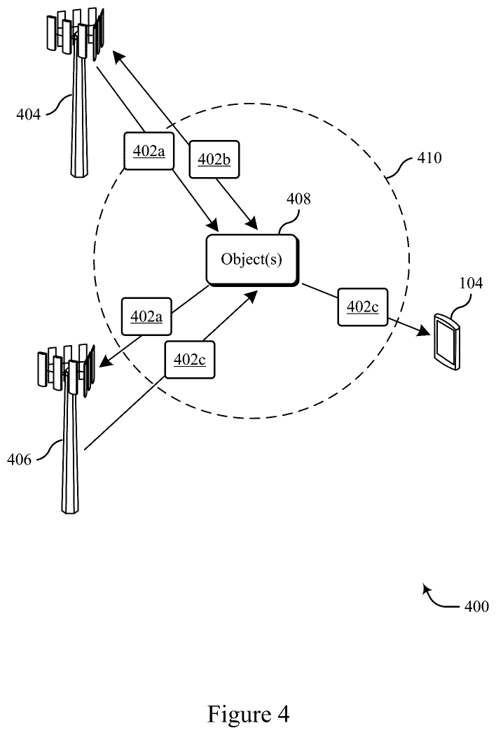

FIG. 4 illustrates example scenarios 400 for radio sensing that supports passive radio sensing measurements in accordance with aspects of the present disclosure. The scenarios 400 include a scenario 402a with a sensing Tx device as a network node 404 and a sensing Rx device as a separate network node 406, which represent different instances of network entities 102. In the scenario 402a, the sensing RS (and/or another RS used for sensing or data and/or control channels known to the network TRP nodes) is transmitted and received by network entities 102. The involvement of UE nodes can be limited, such as to aspects of interference management. The network may not utilize UEs for sensing assistance in the scenario 402a.

The scenarios also include scenario 402b with a sensing Tx device as the network node 404 and sensing Rx device as the same network node 404. In the scenario 402b, the sensing RS (and/or another RS used for sensing or the data and/or control channels known to the network TRP nodes) is transmitted and received by the same network entity 102. The involvement of UE nodes can be limited, such as to aspects of interference management. The network may not utilize UEs for sensing assistance in the scenario 402b. The scenarios also include scenario 402c with a sensing Tx device as the network node 406 and a sensing Rx device as a UE 104. In the scenario 402c, the sensing RS or other RS used for sensing is transmitted by a network entity 102 and received by one or multiple UEs 104. A network, for instance, configures the UE(s) 104 to perform as a sensing Rx node, such as according to the UE nodes capabilities for sensing and/or a specified sensing task. As part of the scenarios 402a-402c, the radio sensing is implemented to detect feature characteristics of objects 408 present in an environment 410.

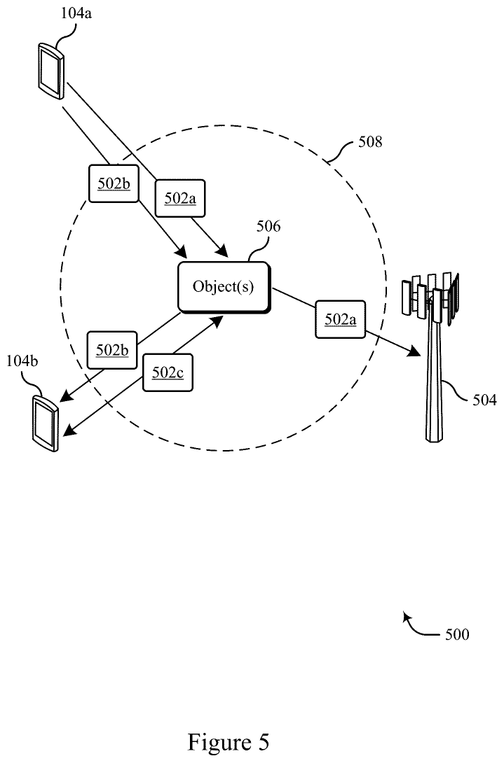

FIG. 5 illustrates example scenarios 500 for radio sensing that supports passive radio sensing measurements in accordance with aspects of the present disclosure. The scenarios 400 and 500 can represent additional and/or alternative implementations. The scenarios 500 include a scenario 502a with a sensing Tx device as a UE 104a and a sensing Rx device as a network node 504. In the scenario 502a, the sensing RS or other RS used for sensing (and/or a data and/or control channel transmitted by the UE 104a) is received by one or multiple network entities 102 (e.g., the network node 504) and transmitted by the UE 104a. A network, for instance, configures the UE 104a to perform as a sensing Tx node, such as according to the UE 104a capabilities for sensing and/or a specified sensing task.

The scenarios 500 include a scenario 502b with a sensing Tx device as the UE 104a and a sensing Rx device as a separate UE 104b. In the scenario 502b, the sensing RS or other RS used for sensing is received by one or multiple UEs 104b and transmitted by the UE 104a. In this scenario, the network and/or a UE 104 may decide on a configuration of the sensing scenario. In at least one example, a network configures the UEs 104 to perform as a sensing Tx node and/or as a sensing Rx node, such as according to the UE 104 capabilities for sensing and/or a specified sensing task. The scenarios also include scenario 502c with a sensing Tx device as the UE 104b and sensing Rx device as the same UE 104b. In the scenario 502c, the sensing RS (and/or another RS used for sensing and/or the data and/or control channels known to the UE) is transmitted by the UE 104b and received by the same UE 104b. In at least one implementation, the UE 104b and/or a network configures the sensing scenario, such as according to the UE 104 capabilities for sensing and/or a specified sensing task.

As part of the scenarios 502a-502c, the radio sensing is implemented to detect feature characteristics of objects 506 present in an environment 508. Further, the different scenarios 502 are presented for the purpose of examples only, and it is to be appreciated that implementations for passive radio sensing measurements can be employed in a variety of different scenarios, including scenarios not expressly described herein.

The implementations described herein are not intended to be restricted to a specific UE type and may include any UE category. For instance, the roles elaborated for a gNB and/or UE may be replaced (with equal validity for any example of a radio sensing scenario) with any UE or RAN node, e.g., a smart repeater node, an IAB node, a roadside unit (RSU), etc. In at least some examples, a set of sensing Tx nodes of a sensing measurement process (and similarly, but may be independently, a sensing Rx nodes of a sensing measurement process) include one or more of a TRP associated to a gNB-CU/DU, a gNB-DU, a gNB-CU, a UE, a neighbor cell relation (NCR), an IAB node, an RSU, a dedicated sensing radio, etc. In implementations a sensing Rx node may be implemented as a non-3GPP sensor with capability of providing non-3GPP sensing data, and/or a 3GPP node (e.g., a UE or a RAN node) connected to the non-3GPP sensor and that can obtain, process, and transfer the non-3GPP sensing data of the non-3GPP sensor to other 3GPP nodes and/or entities.

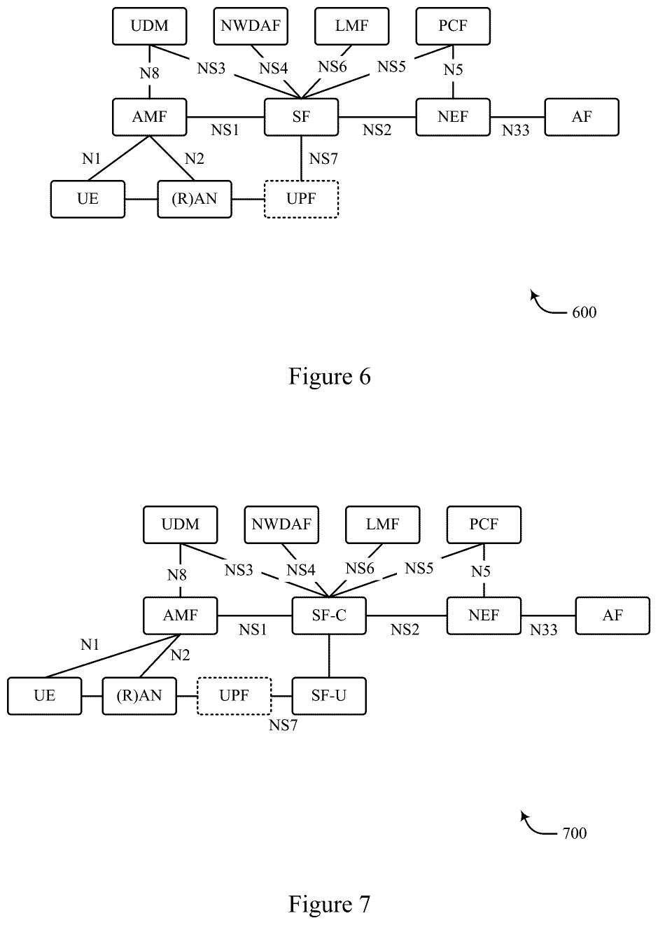

FIG. 6 illustrates a scenario 600 for a tight coupling ISAC network architecture. In the scenario 600 the SF appears as a dedicated network function (NF) handling both: (i) the sensing control plane aspects such as the interaction with the sensing consumer via Network Exposure Function (NEF) and information exchange with other NFs, for gathering UE information, (i.e., from the Access and Mobility Management Function (AMF), Unified Data Management (UDM), Location Management Function (LMF), UE related policies from the Policy Control Function (PCF), and analytics from the Network Data Analytics Function (NWDAF)) and (ii) the sensing radio signals for performing the analysis or prediction for determining the sensing target.

FIG. 7 illustrates a scenario 700 for a tight coupling ISAC network architecture. In the scenario 700 a control plane/user plane (CP/UP) split is implemented where the SF has two dedicated NF counter parts: (i) SF-C that handles the control plane aspects as described above and (ii) SF-U that is responsible for collecting the sensing radio signals via the user plane, i.e., via the RAN and User Plane Function (UPF). The idea of this architecture is to split and offload heavy data volumes associated with sensing radio signals to the user plane to ensure light traffic, i.e., only singling, in the control plane.

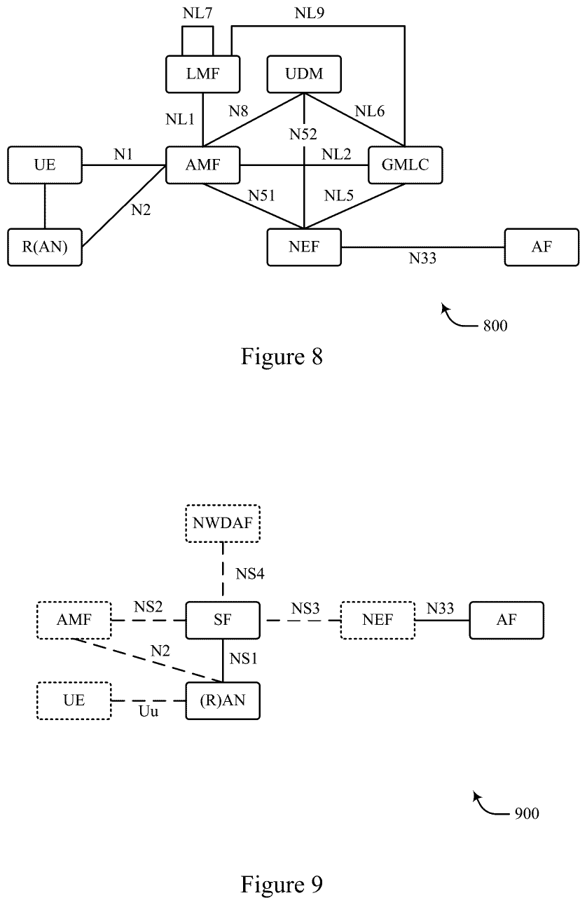

FIG. 8 illustrates a scenario 800 where an SF is collocated with the LMF. For instance, the scenario 800 the SF/LMF appears as a logical NF embedded in the LMF to perform sensing taking advantage of the knowledge of a UE location.

FIG. 9 illustrates a scenario 900 for loose coupling ISAC network architecture. In the scenario 900 the SF is independent of the 5G core, e.g., typically used for local field scenarios or private networks and the interaction with the 5G core is minimal. A primary implementation is to use the SF close to the RAN (e.g., collect and process the sensing radio signals locally) and interact with 5G core for the purpose of exposure via NEF, e.g., for obtaining the UE location from the AMF and for analytics (NWDAF).

In some example implementations, a sensing controller entity/function (e.g., sensMF) is defined which includes one or multiple of a UE, a RAN node, a gNB/gNB-CU, an LMF, an SF, or a combination thereof, where the sensMF performs one or multiple of: (a) receiving request for sensing information from a service consumer (e.g., a requesting third party application); (b) determining selection and/or configuration of a sensing operation, including configuration of one or more of a sensing Tx node, sensing Rx node; (c) selecting and/or configuring the involved nodes for sensing transmission and sensing reception and sensing measurement and reporting of the conducted measurements; (d) collecting the sensing measurements; (e) performing, configuring, and/or requesting computation of the sensing measurements and thereby determining sensing information based on the obtained sensing measurements; (f) reporting and/or exposing an obtained sensing information to the entity requesting the sensing information.

In some examples a sensMF includes multiple nodes and/or entities, and one or more first parts of the above-mentioned steps may be implemented by the first part of the sensMF and one or more second parts of the above steps may be implemented by the second part of the sensMF, e.g., implemented in the SF and gNB. In some examples where the sensMF includes multiple nodes/entities, communication among the sensMF entities can be transparent to outside entities. Further, communication among the sensMF entities can be assumed to be implicit to the overall procedure. In some examples, where a sensMF is includes an SF and a gNB (e.g., serving/head gNB of a related UE to the sensing task or a selected serving gNB for a sensing task), the SF can perform steps a, f, e, d (above) and the steps b, c can be performed by the selected gNB node.

In some implementations the steps b, d above are jointly performed by the SF and the selected gNB, where a first part of the configuration/configuration determination are performed by the SF and a second part of the configuration/configuration determination is performed by the selected gNB. The sensMF may be a RAN node (e.g., a selected gNB node acting as serving gNB of a sensing task), a sensing function (SF) residing in core network, a UE, and/or a combination thereof.

In the discussion of implementations described herein it is understood that the disclosure is not limited to any single example, solution, and/or implementation of elements individually, and one or more elements described herein may be combined in various ways. Further, it is understood that a passive sensing operation may be interpreted as a sensing operation where the sensing measurements are performed at least in part over a non-reference signal, e.g., a signal for which embedded and/or modulated data (e.g., data bit sequence), information, and/or an embedded sequence is not known. The described implementations, however, are not limited to such interpretations and it is understood that they may be equally applicable for any sensing operation and/or measurement utilizing any type of reference signal.

According to implementations a sensMF receives one or multiple requests for sensing service/information (e.g., including description of a sensing task/information, location/area to be sensed, sensing key performance indicators (KPIs) associated to the requested sensing information as described in 3GPP technical report (TR) 22.837) and subsequently discover and/or selects and configures one or more of sensing radio node (e.g., a UE, a gNB, and/or TRP) with a passive sensing measurement configuration which can include: parameters associated with a sensing signal, e.g., describing or indicating time/frequency resources of a sensing signal, where the transmission of the sensing signal within the indicated time-frequency resources illuminates an area of interest for sensing/a potential sensing target area; parameters defining one or more of a reference beam and/or a first signal received via the reference beam; parameters defining one or more of a sensing beam and/or a second signal received via the sensing beam; indication of a function to be computed from the first signal obtained based on the application of the one or multiple reference beams to the received sensing signal, hereafter termed as x(t) and the second signal obtained from the application of the one or multiple sensing beam to the received sensing signal, hereafter termed as y(t); and/or a reporting configuration of the value of the computed function.

Based on reception of the report of the one or more passive sensing measurements of the radio nodes, the sensMF derives one or more sensing results corresponding to the received sensing requests. In implementations parameters defining a beam used for the passive sensing measurements (e.g., reference beam and/or the sensing beam) may include one or more of:

An indication of a path, e.g., a path description, a path ID, a previously detected/reported and/or tracked (tracked, e.g., in case the path direction, delay, properties change over time. In some examples the path may be associated to a moving target, and the path parameters and/or properties (e.g., angle, delay etc.) at the radio node can updated based on the target mobility propagation path (e.g., between a transmitter and a receiver node) by the radio node, and the radio node may select a beam and/or a reception filter most aligned with the path. This alignment may be based, for instance, on an indication of a line of sight (LOS) path condition between the transmitter and the radio node, e.g., a beam with a highest RSRP of an indicated RS determined to be received with a LOS path, a beam with the highest RSRPP of a path with LOS condition towards the receiver. As another example the alignment may be based on an indication of a reflective path known to the radio node, e.g., a previously reported path as a detected path with information of AoA/ZoA path delay path doppler shift etc. and/or a path associated with a known or indicated reflector to the radio node (e.g., an NCR node or a reconfigurable intelligent surface (RIS), a known/static object), which may further include the reflector position, reflection time pattern, the reflection arrival angle (azimuth & elevation of arrival to the radio node), time pattern of the reflection, etc.

Additionally or alternatively the path alignment can be based on an indication of a path with a static or dynamic property in time (e.g., incurring a doppler shift to the transmitted signal) and a beam and/or filter determined by the radio node based on the path may include a spatial domain beam and/or filter aligned with the path in the AoA, ZoA, a doppler filtering, and/or a time-domain filtering (e.g., a matched filter, a Wiener filter for the reception of the signal from the path) applied on received signal samples at a radio node within a window of time and/or a block of symbols.

Additionally, or alternatively a beam used for passive sensing measurements (e.g., reference beam and/or sensing beam) may include one or more of Indication of a QCL type-D relation, a Tx or Rx beam ID of the radio node among the previously measured or reported beams associated to the radio node (received by the radio node or transmitted by the radio node).

Additionally, or alternatively a beam used for passive sensing measurements (e.g., reference beam and/or sensing beam) may include one or more of an indication of a beam angular description, an illumination area description, an angle, an area index, a relative angle, a relative area index to an antenna and/or antenna array of a radio node, e.g., a UE. The indication, for instance, can include a beam direction (e.g., in azimuth and elevation) according to a global coordinate system (known to the radio node) or local coordinate system of the radio node. As another example the indication can include a Tx/Rx beam at the radio node is determined based on receiving beam parameters (e.g., in part via an index/values of a beam codebook), where the beam parameters may include (e.g., via direct/explicit indication) and/or be associated with one or more of relative or absolute areas (e.g., relative 2D or 3D areas to the location of the radio node or array of radio node or antenna panel of the radio node where the displacement of the area to the array or a rotated version of the array is given by the indicated relative area); beam angle and/or direction in azimuth and/or elevation; distance to the radio node (e.g., from a point of antenna or antenna array of the radio node); and/or combinations thereof.

According to implementations a receive beam can be determined by a radio node based on received parameters among a set of indicated beams and/or set of determined beams by the radio node based on an indicated criteria and/or determined by the radio node among available beams at the radio node, e.g., as a beam which collects maximum energy from a transmission and/or illumination of a radio frequency (RF) signal from the indicated area and/or angle. In at least some examples two or more beams (e.g., based on the received index or parameters) may correspond to similar azimuth and/or elevation angle with respect to the radio node but correspond to different distances from the radio node.

According to implementations a beam used for passive sensing measurements can be based on a relative angular description to an a priori known beam, direction, and/or path by a radio node, e.g., an angle of a previously detected LOS path with an indicated angular margin and/or distance of degrees of azimuth (e.g., −10, 10) and degrees of elevation (e.g., −15, 15) relative to a path and/or direction.

According to implementations a beam used for passive sensing measurements can be based on an angle of a known path and/or a beam by the radio node, such as adjusted and/or tilted according to an angular description, e.g., a previously detected beam or known path to be shifted 10 degrees in the elevation and 15 degrees in the azimuth direction.

According to implementations a beam used for passive sensing measurements can be based on a reference location towards which a sensing beam can be directed (e.g., position/location area of a sensing target or an area of interest for sensing). This indication may be done subsequent to an indication by the radio node that the position of the radio node is known by the radio node and/or that the radio node shares a coordinate system with the network with an indicated synchronization accuracy of a coordinate system with the network.

According to implementations a beam used for passive sensing measurements can be based on a reference location towards which the sensing beam can be directed. This indication may be generated by the sensMF subsequent to receiving the position information of the radio node. Further, the indication choice may be taken by the sensMF to not reveal meaningful location information of a transmitter/TRP or a target reflection point.

In implementations the sensing beam of the radio node can be determined, at least in part, autonomously based on higher layer (e.g., application) information, e.g., pose direction information of the UE, or a desired sensing direction obtained from an application residing on the UE.

In implementations an indication of a function to be computed from the first signal x(t) and the second signal y(t) can include: (a) A filtering applied on x(t); (b) a filtering applied on y(t); (c) power and/or energy measurement of the signal x(t) or the filtered x(t), e.g. [symbol] |x(t)|²/| [symbol] | where the [symbol] is may be a measurement time window indicated by the network; (d) power energy measurement of the signal y(t) or the filtered y(t), e.g., [symbol] |y(t)|²/| [symbol] | where [symbol] is may be a measurement time window indicated by the network; (e) cross-correlation computation at indicated one or multiple delay taps τ (e.g., delay margin) between x(t) or the filtered x(t) and y(t) or the filtered y(t), e.g., f(τ, x, y)= [symbol] x*(t−τ)y(t)/γ where [symbol] may be a measurement time window indicated by the network and γ is may be a normalization factor indicated to and/or computed at the radio node; (f) harmonics by which a signal received from the reference beam is mixed/multiplied to generate the signal received from the sensing beam, e.g., a joint delay (indicated set or range of τ) and harmonic component analysis (indicated by a frequency or set of frequency or a range of frequencies of f_{D}) of the sensing signal relative to the reference signal, e.g., f(τ, f_{D}, x, y)= [symbol] x*(t−τ)y(t)e^{2πjf}^{_{D}}/γ where the [symbol] ma be a measurement time window indicated by the network, γ is may be a normalization factor indicated to and/or computed at the radio node; (g) an indicated computational model (e.g., an AI/machine learning (ML) model) at least with the signals x(t) and y(t) as input data for inference, where the model has been previously transferred by the network, or available at the radio node for processing and indicated to the network, e.g., as part of the capability description of the radio node; (h) a constant value indicated by the sensMF as part of description of the functions; and/or (i) a summation, multiplication, or composition of any one or multiple of the functions.

In implementations the configuration can include assisting information of the transmission power, autocorrelation structure of the transmitted signal, etc. Further, in implementations the channel of the reference beam has been previously measured at the radio node (e.g., via a previously transmitted signal and performed measurement by the radio node) such that the delay profile of the channel observed from the reference beam is known. Accordingly, an indicated function (e.g., as part of the filtering of x(t)) may include a time-domain combining and/or filtering (e.g., as a RAKE receiver in the form of a matched finite impulse response (FIR) filter in time domain) on the received first signal to temporally align the received paths. In at least one example the second signal is further delayed with a delay based on the length of the FIR filter prior to a cross correlation (and optionally further function) and can be computed between the filtered first signal and the second signal.

In implementations the filtering of the signals x and/or y may include normalization (e.g., a division of an initial value to a second normalizing value) of the signal to a scalar value, where the scalar value may be obtained based on an indicated transmission power of the sensing signal, a received power of the signal x; a received power of the signal y; and/or combinations thereof.

In implementations the filtering of the signals y may include subtraction of the dependency of the signal y to the signal x or to a filtered signal x.

In implementations a function that is applied is determined autonomously at the radio node, such as based on the requested and/or indicated measurement type by the sensMF as part of the passive sensing configuration. Examples of the measurement type include: presence of a target within an indicated distance or indicated delay margin from the signal reception at the radio node from the LOS path, where the detection may be done via comparison of an indicated minimum threshold value to the collected power of the filtered received signal y or based on the summation of the cross correlation values computed between the signal x or the filtered signal x and the signal y or the filtered signal y; difference of arrival delay of the sensing signal from the observed paths from the sensing beam (e.g., paths received at the radio node within an indicated range of azimuth angle of arrival and/or zenith of arrival and/or delay-difference of arrival compared to the LOS path) compared to the LOS path; difference of the doppler shift of the observed paths from the sensing beam (e.g., within a range of angle of arrival or zenith of arrival associated to the sensing target) compared to the LOS path; and/or RSRPP of the all or subset of the observed paths from the sensing beam and/or from the reference beam (e.g., paths detected within a range of angle of arrival or zenith of arrival associated to the sensing target), such as a ratio of a measured RSRPP of an observed beam via the reference beam and the sensing beam, etc.

In implementations configuration of a sensing radio node for passive sensing measurement may be determined (e.g., by the sensMF) based on at least one or more of the capability information received from the radio node for passive sensing measurements; requested one or multiple sensing tasks from the sensMF; availability of the RAT independent sensing data applicable for the available sensing tasks (e.g., associated to the sensing area of interest of the task); availability of the network nodes capable of sensing applicable for the available sensing tasks (e.g., associated to the sensing area of interest of the task); and/or availability of the signal transmissions into the same direction/area of interest for sensing by the radio nodes.

In implementations capability information can include one or more of: support for passive sensing measurements, including at least determination of the reference beam, the sensing beam and performing a passive sensing measurement jointly based on the received sensing signal once via the reference beam and once via the sensing beam; minimum required time for a passive sensing measurement to be ready/computed and can be reported by the UE; max REs, PRBs, maximum time duration over which the measurements can be jointly computed; minimum angular beam separation (e.g., in azimuth, elevation, jointly in azimuth and elevation plane, etc.) between the reference beam and sensing beam; minimum resolvable path angles (e.g., angular resolution for path separation); minimum resolvable delay difference (e.g., delay resolution); minimum resolvable doppler shift difference between the detected paths of the reference beam and sensing beam; type of the supported passive sensing measurement (e.g., including type of the supported function that can be applied on the signals x and y); UE location; LOS reception condition of one or multiple signals/cells (e.g., based on the observed/measured broadcast Synchronization Signal Block (SSB) or data transmissions, based on an indicated/configured reference or DL signal etc.).

In implementations the signal transmissions may include transmission from a network node/a TRP, transmission from a UE device, and may include DL RS (e.g., DL positioning reference signal (PRS), DL channel state information (CSI) reference signal (RS), etc.) uplink (UL) RS (e.g., UL sounding reference signal (SRS)), sidelink (SL) reference signal (RS) (e.g., SL PRS, etc.) and/or may include physical data or control channel transmissions in the DL, UL or sidelink directions.

In implementations when a measurement function is indicated to be a trainable computation model (e.g., AI/ML model, a deep neural network model, etc.), the sensMF may (e.g., upon request of the passive sensing radio node) configure the sensing node for periods of training. Training configuration can include time resources and/or frequency resources for reception of a sensing signal illuminating an area of interest for sensing, a time resource and/or frequency resource for receiving description of the true state of a sensing target, e.g., indication that the sensing target is actually present, the (absolute or relative to a radio node) position of the target, the size, RCS, shape of the target, etc.

In implementations the radio node can receive a reporting configuration from the sensMF including a communication resource and configuration by which a measurement report can be sent and the condition by which the report is to be sent, e.g., upon detection of a path, upon an RSRPP of a detected path is above an indicated threshold, etc.

In implementations a second configured passive sensing measurement can be performed upon completion of a first sensing measurement and/or upon when the obtained first measurement satisfies an indicated condition. For instance, upon detection of a path within an indicated range of delay-difference to the LOS path and/or at an indicated azimuth/elevation range, the measurement of the path doppler difference to the LOS path can be performed by the radio node.

According to implementations a UE capable of passive sensing measurement can be discovered and/or selected by a sensMF for performing passive sensing measurements and configured with parameters to perform and report passive sensing measurements to the sensMF. As such, sensing results and/or information can be obtained by the sensMF via, at least in part, the collected passive sensing measurements of the reporting UE.

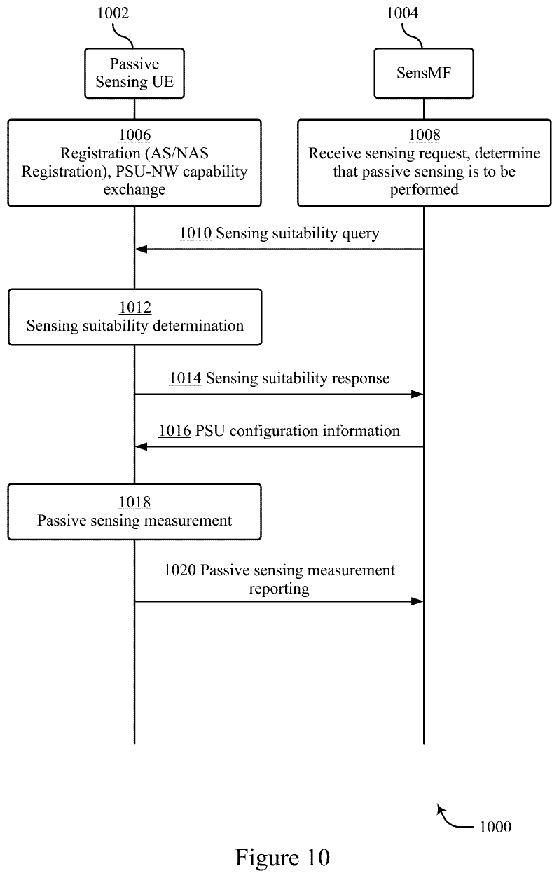

FIG. 10 illustrates an example of a procedure 1000 in accordance with aspects of the present disclosure. The procedure 1000, for instance, represents an example procedure for discovery, selection, and configuration of a passive sensing UE to perform measurement and report the obtained measurements. In this particular example the procedure 1000 involves a passive sensing UE 1002 and a sensMF 1004.

At 1006 registration and capability indication of the UE 1002 is indicated to the network and to the sensMF 1004, and the sensMF 1004 receives sensing service and/or information requests. A UE device capable of performing passive sensing measurements is registered to the RAN (e.g., via obtaining a radio resource control (RRC) connected state) and to the NAS, where the capability of the UE for passive sensing is indicated to and available at the AMF, at the serving gNB of the UE, at the sensMF, or combination thereof. As such, the UE may also be registered by the sensMF. The sensMF may receive and store the UEs' capability information for passive sensing and/or may send a query to the AMF for obtaining the UEs with passive sensing capability, e.g., via sensing a query message for UEs with sensing suitability. The sensMF may hold UE IDs associated with sensing capable UEs, or a shuffled UE IDs, where a one-to-one mapping of the UE IDs to the actual UE IDs is available at the AMF.

At 1008 the sensMF 1004 receives one or multiple requests for sensing service and/or information, including sensing location and/or area, sensing information type (e.g., detection of a human, object, positioning of a target, tracking of a target etc.), and sensing KPI (e.g., positioning accuracy parameters of a sensing target). The sensMF 1004 may determine that utilizing UE-based passive sensing is to be performed, e.g., based on the unavailability of the network radio nodes capable of sensing transmission and/or reception at the requested sensing area, based on the availability of the communication link and/or signal transmissions from one or more RAN nodes and/or TRPs illuminating the same area or transmitted at the same (or approximately the same) azimuth and/or elevation angle as a desired area for sensing requested by the one or multiple sensing services.

In at least some examples, such availability information (e.g., of the radio signal transmissions directed at an area of interest for sensing) can be obtained as a query and response between the sensMF 1004 (e.g., a serving gNB of a sensing task or a core network sensing function) and one or more RAN nodes (e.g., TRPs) associated with the location area of a sensing task, e.g., a core network function SF or a serving gNB of a sensing task requesting information on the available signal transmissions towards a desired sensing direction and/or area from a RAN node associated with a sensing task.

In at least some examples the sensMF 1004 (e.g., the SF residing in core or in RAN, or serving gNB of one or more sensing tasks associated with an area of interest for sensing), subscribes to and/or requests the radio nodes (e.g., RAN nodes, UEs, within/close to/associated to the area of interest for sensing) to transmit to the sensMF indication or description of the signal transmissions when the signal transmissions satisfy an indicated criteria. Examples of such criteria include: when the transmission of the signal by the radio node illuminates all or at least a subset of the area of interest for sensing with an indicated/known minimum received/impinged energy level); when the transmission direction of a signal transmission is aligned (e.g., is within an indicated angular azimuth/elevation difference) with the direction of the point/area of interest for sensing; when the transmission point of a signal transmission is within an indicated distance of the area/position of interest for sensing; when the signal transmission occupies/persists a minimum indicated time duration, a minimum indicated frequency domain space (bandwidth, number of resource blocks etc.); or a combination of one or multiple of the above.

In at least some implementations the indication or description of the signal transmission includes all or a subset of the transmission configuration parameters of the signal or set of parameters describing the transmission, e.g., indication of the carrier/frequency band, the start frequency, bandwidth, transmit power, transmission duration, transmission direction, etc.

At 1010 the sensMF 1004 transmits a suitability query message as broadcast or multi-cast or dedicated message for determination of passive sensing UEs suitable for a requested sensing measurement. The suitability message may include the desired passive sensing configuration or a subset thereof (e.g., parameters describing passive sensing measurement), a required/desired capability description for a potential passive sensing UE (a subset or combination of the capability elements such as described above), a maximum distance to an area of interest for sensing (distance of a passive sensing node shall not exceed an indicated threshold towards a sensing point or area described/indicated by the network) a required accuracy of the desired measurement, availability of a LOS condition at the radio node (on at least one) of an indicated one or more transmission.

In at least some implementations the sensMF 1004, responsive to receiving the indication of signal transmission with the indicated criteria and/or description of the signal transmission, requests for additional information on the signal transmission parameters (e.g., more accurate time and/or frequency resources of the transmission. The sensMF may also transmit and/or request for transmission of a broadcast or paging message decodable via an RNTI which is shared with the UEs capable of performing sensing measurements, where the message including suitability criteria/description of UEs for performing a passive sensing measurement.

In implementations the suitability message and/or the suitability determination of a UE for passive sensing measurement may be based on, at least in part, reception of the signals (e.g., signal transmission by the same transmitter and within the same bandwidth part (BWP) or PRBs and at the same direction as the signal by which the passive sensing UE will be indicated to perform passive sensing measurements), e.g., a PDSCH transmission of one or more DL beams (e.g., a periodic transmission resource thereof within an indicated PRBs) are received by a candidate UE for passive sensing measurement once (e.g., within a first set of subframes) for determining the suitability of the UE for a passive sensing measurement and thereafter (e.g., within a set of subsequent subframes) utilized for performing an indicated passive sensing measurement. In some such examples, at least a subset of the parameters describing transmission of the signal (e.g., frequency domain resource pattern) used for suitability determination is also used for the passive sensing measurement of the UE and not retransmitted/indicated to the UE.

At 1012 the passive sensing UE 1002 capable of passive sensing measurement determines suitability based on the received suitability information, including at least one or more of determining LOS condition towards one or more of the indicated transmissions, determining that the UE position is within the described suitable area by the received suitability message, determining that the UE can perform the desired passive sensing measurements according to the received criteria/suitability message, etc.

At 1014 and based on the UE determination of the suitability at step 1012, the passive sensing UE 1002 may transmit a response indicating the UE's suitability for the requested passive sensing measurement. At 1016 the type of measurement, reporting config, etc., may be transmitted by the sensMF to the passive sensing UE 1002, e.g., accompanied with the suitability query 1010.

At 1018 the configured passive sensing UE 1002 performs passive sensing measurement according to the received configuration and at 1020 the passive sensing UE 1002 reports the obtained and/or performed sensing measurement to the sensMF 1004 based on the received reporting configuration from the sensMF 1004.

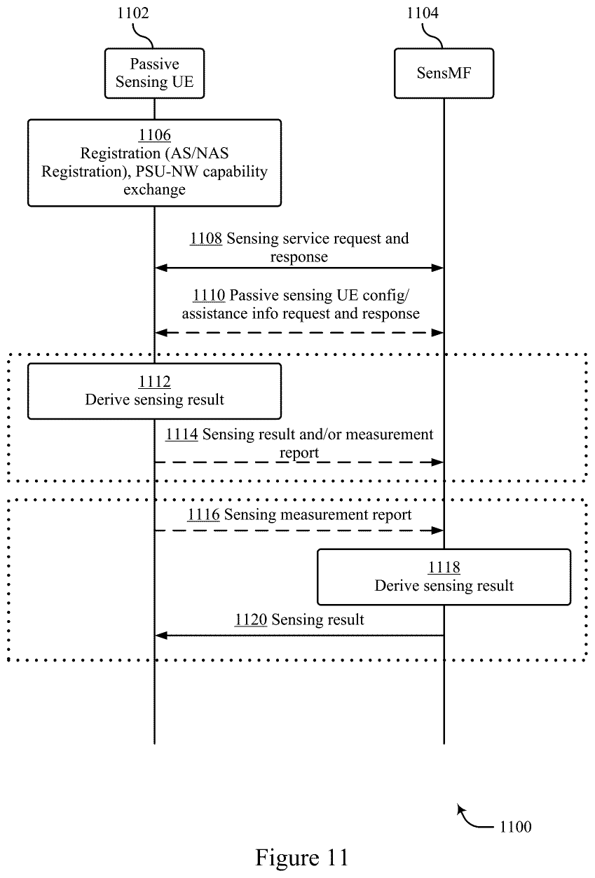

FIG. 11 illustrates an example of a procedure 1100 in accordance with aspects of the present disclosure. The procedure 1100, for instance, involves a passive sensing UE 1102 and a sensMF 1104. In this example, the passive sensing measurement is performed by the passive sensing UE 1102 upon request of an application residing on the UE and/or associated to the UE (shared by the same user) and that the UE (or the application residing on or associated to the UE) requesting network for support of the sensing measurement by the UE, e.g., via transmitting to the UE assisting information enabling the passive sensing measurement of the UE based on the received assisting information.

At 1106 the passive sensing UE 1102 indicates a registration and capability indication of the UE to the network and to the sensMF 1104. Elements of the step 1006 discussed above may also be applied. At 1108 the UE 1102 and/or an application residing on the UE or associated to the UE requests the network and/or sensMF 1104 to support performing passive sensing measurements (e.g., including in the request, e.g., area/direction of interest for sensing, the required illumination level, impinging signal energy density to the area of interest for sensing over unit of time and/or surface of the area of interest, impinging signal duration, impinging signal distance, impinging signal bandwidth, time-frequency pattern etc.) by performing signal transmission in a direction of interest for sensing and informing the passive sensing UE of the necessary assisting information needed to perform sensing measurements on the transmitted signal and/or to obtain and/or derive sensing results.

In at least some implementations when there is no available signal transmission matching the UE 1102 requested signal transmission for passive sensing measurement, the sensMF 1104 responds to the UE 1102 negatively indicating that the signal transmission is not available. In some other example, the sensMF 1104 may support the requesting UE 1102 with scheduling a signal transmission (e.g., of a reference signal, or adjusting one or more of a DL physical data/control channels to match the UE's requested signal transmission) matching the UE's request.

In implementations the network and/or sensMF 1104 may respond positively or negatively to the received request. In some implementations a positive response further includes a request occasion, time-frequency resource indication over which the UE shall perform request for assisting information and/or time-frequency resource indication over which the UE receives assisting information for passive sensing measurement.

At 1110 upon receiving a positive respond to the request, the sensMF 1104 may further transmit and/or the UE 1102 may further request for assisting information for the UE to perform passive sensing measurements. The assisting information may include parameters which can be defined within a sensing measurement configuration such as described above, and may further include additional information for a radio node to interpret the performed measurements as sensing result and/or environment features (e.g., location of the transmission point, velocity of the transmission point, transmit power of the received signal etc.).

At 1112 and as one option, the UE 1102 derives the sensing result locally based on the received assisting information from the sensMF 1104 and, at least in part, the performed passive sensing measurements. At 1114, 1116 and as another option performed passive sensing measurements are reported by the UE 1102 to the sensMF 1104.

As another option at 1118 the sensMF derives the sensing result based on, at least in part, the reported passive sensing measurements of the UE, and where the assisting information required to interpret the measurements and derive the sensing results are not exposed to the UE 1102 and remain protected at the sensMF 1104 and/or network. As another option at 1116 the performed passive sensing measurements and/or the derived passive sensing results are reported by the UE to the sensMF. In some examples, this may be done optionally or upon request of the sensMF 1104. As another option at 1120 the sensMF 1104 informs the UE 1102 of the derived sensing results.

In implementations any of the configurations (of a sensing signal, a sensing transmission, sensing reception, sensing measurement, suitability query) and/or indications and/or reporting information elements between a sensing node and the sensMF or a subset thereof can be received by the sensing Rx nodes; transmitted by the sensing Rx nodes; received by the sensing Tx nodes; transmitted by the sensing Tx nodes; transmitted and/or received by the sensMF node; or any combination thereof, and via the UL, DL or SL physical data and/or control channels defined within the communication network, e.g., new radio physical broadcast channel (NR PBCH), PDSCH, PDCCH, physical uplink shared channel (PUSCH), physical uplink control channel (PUCCH), physical sidelink broadcast channel (PSBCH), physical sidelink control channel (PSCCH), physical sidelink shared channel (PSSCH), via a higher layer (medium access control (MAC) control element (CE)(MAC-CE) or RRC) signaling, where the sensing Rx and/or the sensing Tx node is a UE; via a logical interface between the SF and the Sensing nodes, as part of the LTE positioning protocol (LPP) or as modified/enhanced LPP message framework for sensing or as an interface defined for sensing message exchanges over the N1 interface between the SF and a UE (or an enhanced N1, an interface tailored for sensing), where the sensing Tx and/or sensing Rx node is a UE; via a logical interface between the sensMF and the Sensing nodes, as part of the NRPPa (or modified/enhanced NRPPa message framework for sensing) or as an interface defined over the Next Generation Application Protocol (NGAP) or N2 (or an enhanced N2, an interface tailored for sensing and/or other services) interface, where the sensing Tx and/or sensing Rx node is a TRP of RAN and the sensMF is a core network function (SF, LMF, etc.; via a logical interface between the sensMF and the Sensing nodes where the sensMF is a serving gNB of a sensing task and the sensing node is a UE or a TRP of RAN. In at some implementations the interface utilizes (at least in part) the X2 interface between the associated gNB of the sensing node and the serving gNB of the sensing task. Further, a combination of one or multiple of the above signaling mechanisms may be utilized.

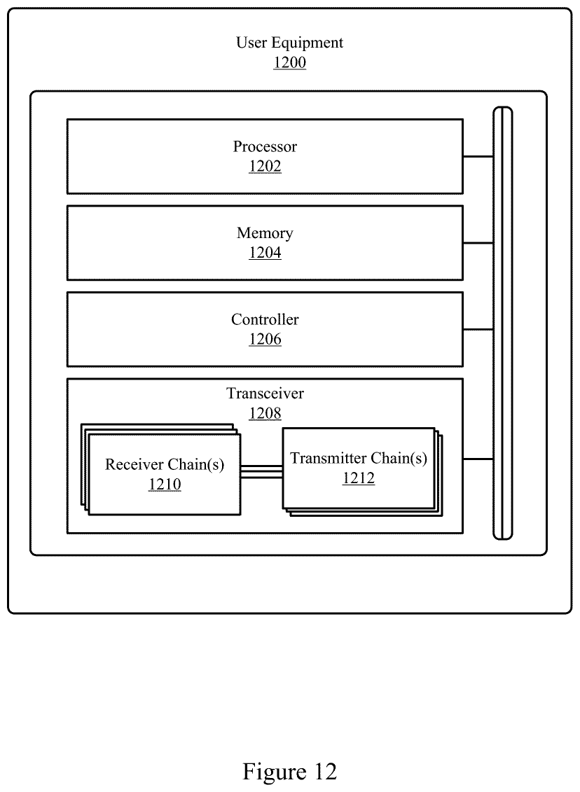

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein.

The UE 1200 may be configured to or operable to support a means for receiving measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and performing a passive sensing measurement based at least in part on the received measurement configuration.

Additionally, the UE 1200 may be configured to support any one or combination of where the sensing signal is indicated to illuminate a sensing target area of interest; receiving reporting configuration for reporting the passive sensing measurement; and transmitting a report of the passive sensing measurement and according to the reporting configuration; at least one of the one or more second parameters or the one or more third parameters include one or more of: at least one of an indication of one or more propagation paths of the wireless channel that are one or more of received by the UE or transmitted by the UE, the at least one indication of the one or more paths including one or more of a path, a path identifier, a path description, a previously detected path, a previously reported path, or a previously tracked path; at least one of an object indicated to the UE via an object ID, the object is one or more of previously defined for the UE detected, reported by the UE, tracked by the UE, or measured by the UE; at least one of an indication of a QCL type-D relation, a transmit beam identifier, or a receive beam identifier of the UE among the one or more paths; or relative to one or more of an antenna or an antenna array of the UE, at least one of an indication of a beam angular description, an illumination area description, an angle, an area index, a relative angle, or a relative area index.

Additionally, the UE 1200 may be configured to support any one or combination of where the path description includes one or more values for one or more of azimuth, elevation of arrival, elevation of departure, propagation path delay, or doppler shift; the object is indicated to the first apparatus by indicating one or more of object type, object RCS, object position, object area, or object velocity; measurements by the first apparatus include one or more of measurements of path power, delay, angle, or doppler shift associated to the first apparatus; determining the sensing beam based at least in part on one or more of information available at the first apparatus or information that can be obtained by the first apparatus within an indicated time delay; indicating, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application; the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing.

Additionally, the UE 1200 may be configured to support any one or combination of one or more of determining or transmitting a preference of one or more of the sensing signal descriptions for performing passive sensing measurements; and performing, based at least in part on the preference of the one or more of the sensing signal descriptions, the passive sensing measurements based at least in part on reception of a transmission as a preferred signal; indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the first apparatus; the known computational artificial intelligence machine learning models include one or more of: one or more artificial intelligence machine learning models transferred to the UE for sensing measurements; or one or more artificial intelligence machine learning models available at the UE and indicated by the UE to a sensing configuration entity for the passive sensing measurements; receiving an artificial intelligence machine learning model training configuration.

Additionally, the UE 1200 may be configured to support any one or combination of where the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receiving first state information on a state of one or more objects; receiving the sensing signal according to the received training configuration; and performing training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus; obtaining state information on the one or more objects or paths; autonomously obtaining state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the UE to obtain the state information, the method further includes indicating to the network one or more of a type of the obtained information, an accuracy of the obtained information, or a resolution of the obtained information.

Additionally, the UE 1200 may be configured to support any one or combination of where a type of the obtained information includes an information source; reporting, to a network entity, a status of the computational artificial intelligence machine learning model, the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receiving a suitability query including suitability criteria for performing the passive sensing measurement, the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria.

Additionally, the UE 1200 may be configured to support any one or combination of receiving the suitability query via one or more of a broadcast message, a multicast message, dedicated signaling in a connected state, a paging message with a group RNTI associated with sensing, or a paging RNTI with a UE identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receiving a first set of one or more downlink beams including a suitability query for performing the passive sensing measurement; and receiving a second set of one or more downlink beams for performing the passive sensing measurement.

Additionally, or alternatively, the UE 1200 may support to receive measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and perform a passive sensing measurement based at least in part on the received measurement configuration.

Additionally, the UE 1200 may be configured to support any one or combination of where the sensing signal is indicated to illuminate a sensing target area of interest; receive reporting configuration for reporting the passive sensing measurement; and transmit a report of the passive sensing measurement and according to the reporting configuration; at least one of the one or more second parameters or the one or more third parameters include one or more of: at least one of an indication of one or more propagation paths of the wireless channel that are one or more of received by the first apparatus or transmitted by the first apparatus, the at least one indication of the one or more paths including one or more of a path, a path identifier, a path description, a previously detected path, a previously reported path, or a previously tracked path; at least one of an object indicated to the first apparatus via an object ID, the object is one or more of previously defined for the first apparatus detected, reported by the first apparatus, tracked by the first apparatus, or measured by the first apparatus.

Additionally, the UE 1200 may be configured to support any one or combination of where at least one of an indication of a QCL type-D relation, a transmit beam identifier, or a receive beam identifier of the first apparatus among the one or more paths; or relative to one or more of an antenna or an antenna array of the first apparatus, at least one of an indication of a beam angular description, an illumination area description, an angle, an area index, a relative angle, or a relative area index; the path description includes one or more values for one or more of azimuth, elevation of arrival, elevation of departure, propagation path delay, or doppler shift; the object is indicated to the first apparatus by indicating one or more of object type, object RCS, object position, object area, or object velocity; measurements by the first apparatus include one or more of measurements of path power, delay, angle, or doppler shift associated to the first apparatus; the at least one processor is configured to cause the first apparatus to determine the sensing beam based at least in part on one or more of information available at the first apparatus or information that can be obtained by the first apparatus within an indicated time delay; the at least one processor is configured to cause the first apparatus to indicate, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application.

Additionally, the UE 1200 may be configured to support any one or combination of where the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing; one or more of determine or transmit a preference of one or more of the sensing signal descriptions for performing passive sensing measurements; and perform, based at least in part on the preference of the one or more of the sensing signal descriptions, the passive sensing measurements based at least in part on reception of a transmission as a preferred signal; indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the first apparatus; the known computational artificial intelligence machine learning models include one or more of: one or more artificial intelligence machine learning models transferred to the first apparatus for sensing measurements; or one or more artificial intelligence machine learning models available at the first apparatus and indicated by the first apparatus to a sensing configuration entity for the passive sensing measurements.

Additionally, the UE 1200 may be configured to support any one or combination of to receive an artificial intelligence machine learning model training configuration, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receive first state information on a state of one or more objects; receive the sensing signal according to the received training configuration; and perform training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus.

Additionally, the UE 1200 may be configured to support any one or combination of where the at least one processor is configured to cause the first apparatus to obtain state information on the one or more objects or paths; the at least one processor is configured to cause the first apparatus to autonomously obtain state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the first apparatus to obtain the state information, the at least one processor is configured to cause the first apparatus to indicate to the network one or more of a type of the obtained information, an accuracy of the obtained information, or a resolution of the obtained information; a type of the obtained information includes an information source; the at least one processor is configured to cause the first apparatus to report, to a network entity, a status of the computational artificial intelligence machine learning model.

Additionally, the UE 1200 may be configured to support any one or combination of where the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receive a suitability query including suitability criteria for performing the passive sensing measurement, the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria.

Additionally, the UE 1200 may be configured to support any one or combination of where the at least one processor is configured to cause the first apparatus to receive the suitability query via one or more of a broadcast message, a multicast message, dedicated signaling in a connected state, a paging message with a group RNTI associated with sensing, or a paging RNTI with a first apparatus identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receive a first set of one or more downlink beams including a suitability query for performing the passive sensing measurement; and receive a second set of one or more downlink beams for performing the passive sensing measurement.

The UE 1200 may be configured to or operable to support a means for receiving a request for a sensing task associated with an area of interest for sensing; transmitting, to a second apparatus, a message including a suitability query for a passive sensing measurement of the area of interest for sensing; receiving a response including a suitability indication for performing passive sensing measurements of the area of interest for sensing; and transmitting, to the second apparatus, measurement configuration for performing passive sensing measurements of the area of interest.

Additionally, the UE 1200 may be configured to support any one or combination of receiving reports of the passive sensing measurements from the second apparatus; computing the sensing results associated to the received sensing tasks; and transmitting the obtained sensing results to the requester of the sensing task; the first apparatus includes a network entity and the second apparatus includes a user equipment (UE); the first apparatus includes a first user equipment (UE) and the second apparatus includes a second UE; determining information including at least one of one or more transmissions of physical data, one or more transmissions of control signals, or one or more transmissions of reference signals illuminating the area of interest for sensing; determining the information via communication with a RAN node and via sensing a query and response toward a gNB assigned for a sensing task; transmitting the message including the suitability query via one or more of a broadcast message or a groupcast message; the suitability query includes one or more of: passive sensing configuration; a capability description for a passive sensing user equipment (UE); a maximum distance to the area of interest for sensing; an accuracy value for a passive sensing measurement; or an availability indication for a line of sight condition at the second apparatus; transmitting a first set of one or more downlink beams including the suitability query; and transmitting a second set of one or more downlink beams for performing the passive sensing measurement.

Additionally, or alternatively, the UE 1200 may support to receive a request for a sensing task associated with an area of interest for sensing; transmit, to a second apparatus, a message including a suitability query for a passive sensing measurement of the area of interest for sensing; receive a response including a suitability indication for performing passive sensing measurements of the area of interest for sensing; and transmit, to the second apparatus, measurement configuration for performing passive sensing measurements of the area of interest.

Additionally, the UE 1200 may be configured to support any one or combination of to receive reports of the passive sensing measurements from the second apparatus; compute sensing results associated to the received sensing tasks; and transmit the sensing results to the requester of the sensing task; the first apparatus includes a network entity and the second apparatus includes a user equipment (first apparatus); the first apparatus includes a first user equipment (first apparatus) and the second apparatus includes a second first apparatus; the at least one processor is configured to cause the first apparatus determine information including at least one of one or more transmissions of physical data, one or more transmissions of control signals, or one or more transmissions of reference signals illuminating the area of interest for sensing; the at least one processor is configured to cause the first apparatus to determine the information via communication with a RAN node and via sensing a query and response toward a gNB assigned for a sensing task; the at least one processor is configured to cause the first apparatus to transmit the message including the suitability query via one or more of a broadcast message or a groupcast message; the suitability query includes one or more of: passive sensing configuration; a capability description for a passive sensing user equipment (first apparatus); a maximum distance to the area of interest for sensing; an accuracy value for a passive sensing measurement; or an availability indication for a line of sight condition at the second apparatus; transmit a first set of one or more downlink beams including the suitability query; and transmit a second set of one or more downlink beams for performing the passive sensing measurement.

The UE 1200 may be configured to or operable to support a means for transmitting measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receiving a passive sensing measurement based at least in part on the received measurement configuration.

Additionally, the UE 1200 may be configured to support any one or combination of transmitting the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmitting a query to the RAN node; and receiving a response from the RAN node indicating one or more of the first availability information or the second availability information; requesting that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level.

Additionally, the UE 1200 may be configured to support any one or combination of where an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space; the indication that the transmission direction of the signal transmission is aligned includes one or more of an angular azimuth or an elevation difference; transmitting a request for additional information for one or more signal transmission parameters; and transmitting a request message for transmission of a message decodable via a RNTI which is sharable with one or more user equipment (UE) capable of performing sensing measurements, the request message including one or more of suitability criteria or description of UE for performing a passive sensing measurement; the request for additional information includes a request for one or more of more accurate time resources or more accurate frequency resources for signal transmission.

Additionally, or alternatively, the UE 1200 may support to transmit measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receive a passive sensing measurement based at least in part on the received measurement configuration.

Additionally, the UE 1200 may be configured to support any one or combination of where the at least one processor is configured to cause the first apparatus to transmit the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmit a query to the RAN node; and receive a response from the RAN node indicating one or more of the first availability information or the second availability information; the at least one processor is configured to cause the first apparatus to request that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level; an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space.

Additionally, the UE 1200 may be configured to support any one or combination of where the indication that the transmission direction of the signal transmission is aligned includes one or more of an angular azimuth or an elevation difference; transmit a request for additional information for one or more signal transmission parameters; and transmit a request message for transmission of a message decodable via a RNTI which is sharable with one or more user equipment (first apparatus) capable of performing sensing measurements, the request message including one or more of suitability criteria or description of first apparatus for performing a passive sensing measurement; the request for additional information includes a request for one or more of more accurate time resources or more accurate frequency resources for signal transmission.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

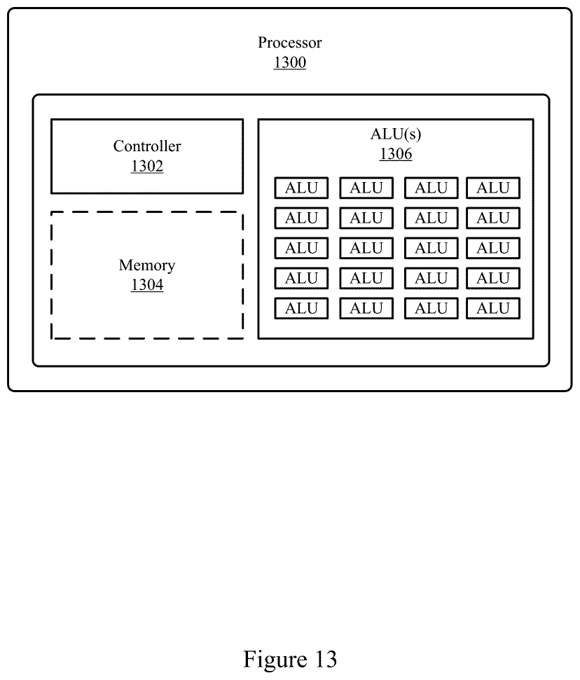

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to receive measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and perform a passive sensing measurement based at least in part on the received measurement configuration.

Additionally, the processor 1300 may be configured to support any one or combination of where the sensing signal is indicated to illuminate a sensing target area of interest; receive reporting configuration for reporting the passive sensing measurement; and transmit a report of the passive sensing measurement and according to the reporting configuration; at least one of the one or more second parameters or the one or more third parameters include one or more of: at least one of an indication of one or more propagation paths of the wireless channel that are one or more of received by the processor or transmitted by the processor, the at least one indication of the one or more paths including one or more of a path, a path identifier, a path description, a previously detected path, a previously reported path, or a previously tracked path; at least one of an object indicated to the processor via an object ID, the object is one or more of previously defined for the processor detected, reported by the processor, tracked by the processor, or measured by the processor; at least one of an indication of a QCL type-D relation, a transmit beam identifier, or a receive beam identifier of the processor among the one or more paths; or relative to one or more of an antenna or an antenna array of the processor, at least one of an indication of a beam angular description, an illumination area description, an angle, an area index, a relative angle, or a relative area index.

Additionally, the processor 1300 may be configured to support any one or combination of where the path description includes one or more values for one or more of azimuth, elevation of arrival, elevation of departure, propagation path delay, or doppler shift; the object is indicated to the processor by indicating one or more of object type, object RCS, object position, object area, or object velocity; measurements by the processor include one or more of measurements of path power, delay, angle, or doppler shift associated to the processor; the at least one controller is configured to cause the processor to determine the sensing beam based at least in part on one or more of information available at the processor or information that can be obtained by the processor within an indicated time delay; the at least one controller is configured to cause the processor to indicate, to a network, availability of the information at the processor or capability of the processor to obtain the information; the information available at the processor includes one or more of pose information, heading of the processor, movement direction of the processor, a direction, or area of interest for sensing determined by a processor application; the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing; one or more of determine or transmit a preference of one or more of the sensing signal descriptions for performing passive sensing measurements; and perform, based at least in part on the preference of the one or more of the sensing signal descriptions, the passive sensing measurements based at least in part on reception of a transmission as a preferred signal.

Additionally, the processor 1300 may be configured to support any one or combination of where the indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the processor; the known computational artificial intelligence machine learning models include one or more of: one or more artificial intelligence machine learning models transferred to the processor for sensing measurements; or one or more artificial intelligence machine learning models available at the processor and indicated by the processor to a sensing configuration entity for the passive sensing measurements; receive an artificial intelligence machine learning model training configuration, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receive first state information on a state of one or more objects.

Additionally, the processor 1300 may be configured to support any one or combination of to receive the sensing signal according to the received training configuration; and perform training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the processor; the at least one controller is configured to cause the processor to obtain state information on the one or more objects or paths; the at least one controller is configured to cause the processor to autonomously obtain state information on the one or more objects or paths via application layer information; availability of the state information of the one or more objects at the processor or capability to obtain the state information of the one or more objects or paths is previously indicated to a network node.

Additionally, the processor 1300 may be configured to support any one or combination of where availability of the state information of the one or more objects at the processor is based on one or more of RAT-independent sensors including one or more of a camera or a motion sensor, and the capability to obtain the state information includes information available at an application layer of the processor; as part of one or more of the indication to the network by the processor of the availability of the state information or the capability of the processor to obtain the state information, the at least one controller is configured to cause the processor to indicate to the network one or more of a type of the obtained information, an accuracy of the obtained information, or a resolution of the obtained information; a type of the obtained information includes an information source; the at least one controller is configured to cause the processor to report, to a network entity, a status of the computational artificial intelligence machine learning model, the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam.

Additionally, the processor 1300 may be configured to support any one or combination of to receive a suitability query including suitability criteria for performing the passive sensing measurement, the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria; the at least one controller is configured to cause the processor to receive the suitability query via one or more of a broadcast message, a multicast message, dedicated signaling in a connected state, a paging message with a group RNTI associated with sensing, or a paging RNTI with a processor identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receive a first set of one or more downlink beams including a suitability query for performing the passive sensing measurement; and receive a second set of one or more downlink beams for performing the passive sensing measurement.

The processor 1300 may support wireless communication in accordance with examples as disclosed herein. The processor 1300 may be configured to or operable to receive a request for a sensing task associated with an area of interest for sensing; transmit, to a second apparatus, a message including a suitability query for a passive sensing measurement of the area of interest for sensing; receive a response including a suitability indication for performing passive sensing measurements of the area of interest for sensing; and transmit, to the second apparatus, measurement configuration for performing passive sensing measurements of the area of interest.

Additionally, the processor 1300 may be configured to support any one or combination of to receive reports of the passive sensing measurements from the second apparatus; compute sensing results associated to the received sensing tasks; and transmit the sensing results to the requester of the sensing task; the processor includes a network entity and the second apparatus includes a user equipment (processor); the processor includes a first user equipment (processor) and the second apparatus includes a second processor; the at least one processor is configured to cause the processor determine information including at least one of one or more transmissions of physical data, one or more transmissions of control signals, or one or more transmissions of reference signals illuminating the area of interest for sensing; the at least one controller is configured to cause the processor to determine the information via communication with a RAN node and via sensing a query and response toward a gNB assigned for a sensing task; the at least one controller is configured to cause the processor to transmit the message including the suitability query via one or more of a broadcast message or a groupcast message; the suitability query includes one or more of: passive sensing configuration; a capability description for a passive sensing user equipment (processor); a maximum distance to the area of interest for sensing; an accuracy value for a passive sensing measurement; or an availability indication for a line of sight condition at the second apparatus; transmit a first set of one or more downlink beams including the suitability query; and transmit a second set of one or more downlink beams for performing the passive sensing measurement.

The processor 1300 may support wireless communication in accordance with examples as disclosed herein. The processor 1300 may be configured to or operable to transmit measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receive a passive sensing measurement based at least in part on the received measurement configuration.

Additionally, the processor 1300 may be configured to support any one or combination of where the at least one controller is configured to cause the processor to transmit the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmit a query to the RAN node; and receive a response from the RAN node indicating one or more of the first availability information or the second availability information; the at least one controller is configured to cause the processor to request that one or more RAN nodes transmit, to the processor, one or more signal transmissions that satisfy one or more signal criteria, the one or more signal criteria including at least one of: an indication that signal transmission by the one or more RAN nodes illuminates at least a subset of an area of interest for sensing with an indicated minimum energy level; an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space; the indication that the transmission direction of the signal transmission is aligned includes one or more of an angular azimuth or an elevation difference; transmit a request for additional information for one or more signal transmission parameters; and transmit a request message for transmission of a message decodable via a RNTI which is sharable with one or more user equipment (e.g., processor) capable of performing sensing measurements, the request message including one or more of suitability criteria or description of processor for performing a passive sensing measurement; the request for additional information includes a request for one or more of more accurate time resources or more accurate frequency resources for signal transmission.

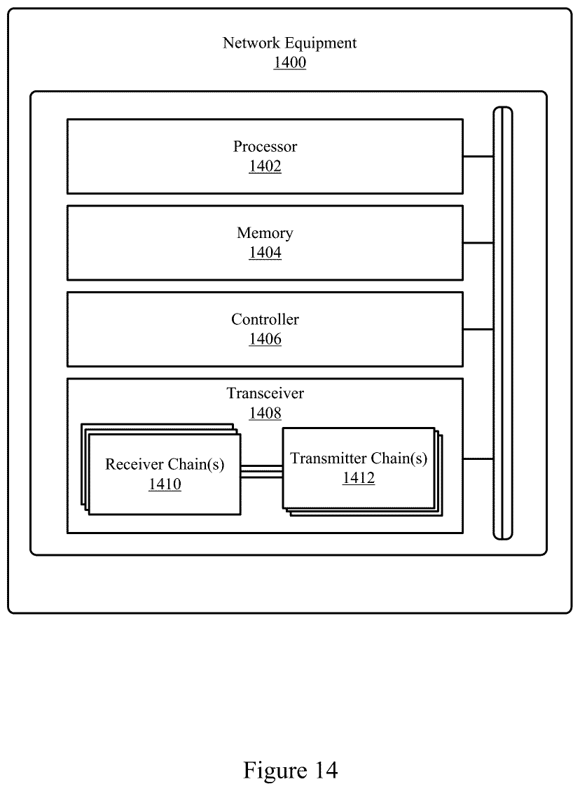

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein.

The NE 1400 may be configured to or operable to support a means for receiving measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and performing a passive sensing measurement based at least in part on the received measurement configuration.

Additionally, the NE 1400 may be configured to support any one or combination of where the sensing signal is indicated to illuminate a sensing target area of interest; receiving reporting configuration for reporting the passive sensing measurement; and transmitting a report of the passive sensing measurement and according to the reporting configuration; at least one of the one or more second parameters or the one or more third parameters include one or more of: at least one of an indication of one or more propagation paths of the wireless channel that are one or more of received by the UE or transmitted by the UE, the at least one indication of the one or more paths including one or more of a path, a path identifier, a path description, a previously detected path, a previously reported path, or a previously tracked path; at least one of an object indicated to the UE via an object ID, the object is one or more of previously defined for the UE detected, reported by the UE, tracked by the UE, or measured by the UE; at least one of an indication of a QCL type-D relation, a transmit beam identifier, or a receive beam identifier of the UE among the one or more paths; or relative to one or more of an antenna or an antenna array of the UE, at least one of an indication of a beam angular description, an illumination area description, an angle, an area index, a relative angle, or a relative area index.

Additionally, the NE 1400 may be configured to support any one or combination of where the path description includes one or more values for one or more of azimuth, elevation of arrival, elevation of departure, propagation path delay, or doppler shift; the object is indicated to the first apparatus by indicating one or more of object type, object RCS, object position, object area, or object velocity; measurements by the first apparatus include one or more of measurements of path power, delay, angle, or doppler shift associated to the first apparatus; determining the sensing beam based at least in part on one or more of information available at the first apparatus or information that can be obtained by the first apparatus within an indicated time delay; indicating, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application.

Additionally, the NE 1400 may be configured to support any one or combination of where the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing; one or more of determining or transmitting a preference of one or more of the sensing signal descriptions for performing passive sensing measurements; and performing, based at least in part on the preference of the one or more of the sensing signal descriptions, the passive sensing measurements based at least in part on reception of a transmission as a preferred signal; indication of the function to be computed includes an indication of a computational artificial intelligence machine learning model.

Additionally, the NE 1400 may be configured to support any one or combination of where the indication of the computational artificial intelligence machine learning model is indicated via an index from a codebook of known computational artificial intelligence machine learning models for performing passive sensing measurements by the first apparatus; the known computational artificial intelligence machine learning models include one or more of: one or more artificial intelligence machine learning models transferred to the UE for sensing measurements; or one or more artificial intelligence machine learning models available at the UE and indicated by the UE to a sensing configuration entity for the passive sensing measurements; receiving an artificial intelligence machine learning model training configuration, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receiving first state information on a state of one or more objects; receiving the sensing signal according to the received training configuration; and performing training of the computational artificial intelligence machine learning model based at least in part on the received sensing signal and the received training configuration.

Additionally, the NE 1400 may be configured to support any one or combination of where the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus; obtaining state information on the one or more objects or paths; autonomously obtaining state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the UE to obtain the state information, the method further includes indicating to the network one or more of a type of the obtained information, an accuracy of the obtained information, or a resolution of the obtained information; a type of the obtained information includes an information source.

Additionally, the NE 1400 may be configured to support any one or combination of where reporting, to a network entity, a status of the computational artificial intelligence machine learning model, the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receiving a suitability query including suitability criteria for performing the passive sensing measurement, the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria.

Additionally, the NE 1400 may be configured to support any one or combination of receiving the suitability query via one or more of a broadcast message, a multicast message, dedicated signaling in a connected state, a paging message with a group RNTI associated with sensing, or a paging RNTI with a UE identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receiving a first set of one or more downlink beams including a suitability query for performing the passive sensing measurement; and receiving a second set of one or more downlink beams for performing the passive sensing measurement.

Additionally, or alternatively, the NE 1400 may support to receive measurement configuration for performing a passive sensing measurement, the measurement configuration including: one or more first parameters associated with a sensing signal, the one or more first parameters including one or more of communication channel resources (e.g., time resources or frequency resources or code resources) of the sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal; and perform a passive sensing measurement based at least in part on the received measurement configuration.

Additionally, the NE 1400 may be configured to support any one or combination of where the sensing signal is indicated to illuminate a sensing target area of interest; receive reporting configuration for reporting the passive sensing measurement; and transmit a report of the passive sensing measurement and according to the reporting configuration; at least one of the one or more second parameters or the one or more third parameters include one or more of: at least one of an indication of one or more propagation paths of the wireless channel that are one or more of received by the first apparatus or transmitted by the first apparatus, the at least one indication of the one or more paths including one or more of a path, a path identifier, a path description, a previously detected path, a previously reported path, or a previously tracked path; at least one of an object indicated to the first apparatus via an object ID, the object is one or more of previously defined for the first apparatus detected, reported by the first apparatus, tracked by the first apparatus, or measured by the first apparatus; at least one of an indication of a QCL type-D relation, a transmit beam identifier, or a receive beam identifier of the first apparatus among the one or more paths; or relative to one or more of an antenna or an antenna array of the first apparatus, at least one of an indication of a beam angular description, an illumination area description, an angle, an area index, a relative angle, or a relative area index.

Additionally, the NE 1400 may be configured to support any one or combination of where the path description includes one or more values for one or more of azimuth, elevation of arrival, elevation of departure, propagation path delay, or doppler shift; the object is indicated to the first apparatus by indicating one or more of object type, object RCS, object position, object area, or object velocity; measurements by the first apparatus include one or more of measurements of path power, delay, angle, or doppler shift associated to the first apparatus; the at least one processor is configured to cause the first apparatus to determine the sensing beam based at least in part on one or more of information available at the first apparatus or information that can be obtained by the first apparatus within an indicated time delay; the at least one processor is configured to cause the first apparatus to indicate, to a network, availability of the information at the first apparatus or capability of the first apparatus to obtain the information; the information available at the first apparatus includes one or more of pose information, heading of the first apparatus, movement direction of the first apparatus, a direction, or area of interest for sensing determined by a first apparatus application; the measurement configuration further includes one or more sensing signal descriptions including a transmission description, the transmission description including one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of the area of interest for sensing.

Additionally, the NE 1400 may be configured to support any one or combination of where one or more of determine or transmit a preference of one or more of the sensing signal descriptions for performing passive sensing measurements; and perform, based at least in part on the preference of the one or more of the sensing signal descriptions, the passive sensing measurements based at least in part on reception of a transmission as a preferred signal; indication of the function to be computed includes an indication of a computational artificial intelligence machine learning model; the indication of the computational artificial intelligence machine learning model is indicated via an index from a codebook of known computational artificial intelligence machine learning models for performing passive sensing measurements by the first apparatus; the known computational artificial intelligence machine learning models include one or more of: one or more artificial intelligence machine learning models transferred to the first apparatus for sensing measurements; or one or more artificial intelligence machine learning models available at the first apparatus and indicated by the first apparatus to a sensing configuration entity for the passive sensing measurements.

Additionally, the NE 1400 may be configured to support any one or combination of to receive an artificial intelligence machine learning model training configuration, the training configuration includes one or more of a description of a sensing signal transmitted from a transmission point, the description of the sensing signal including at least one of one or more time resources for transmission, one or more frequency resources for transmission, a transmission power, a transmission energy, a transmission point, an angular description of a transmission beam, or an illumination pattern of a sensing target area; receive first state information on a state of one or more objects; receive the sensing signal according to the received training configuration; and perform training of the computational artificial intelligence machine learning model based at least in part on the received sensing signal and the received training configuration; the information on the state of the one or more objects includes one or more of presence information for the one or more objects, position information for the one or more objects, speed information for the one or more objects, object RCS, object shape, object size, object dimensions, object velocity, direction of object movement, a blockage state of a path, or a blockage state of a path associated with one or more of an angle or a zenith or arrival towards the first apparatus.

Additionally, the NE 1400 may be configured to support any one or combination of where the at least one processor is configured to cause the first apparatus to obtain state information on the one or more objects or paths; the at least one processor is configured to cause the first apparatus to autonomously obtain state information on the one or more objects or paths via application layer information; availability of the state information of the one or more objects at the first apparatus or capability to obtain the state information of the one or more objects or paths is previously indicated to a network node; availability of the state information of the one or more objects at the first apparatus is based on one or more of RAT-independent sensors including one or more of a camera or a motion sensor, and the capability to obtain the state information includes information available at an application layer of the first apparatus; as part of one or more of the indication to the network by the first apparatus of the availability of the state information or the capability of the first apparatus to obtain the state information, the at least one processor is configured to cause the first apparatus to indicate to the network one or more of a type of the obtained information, an accuracy of the obtained information, or a resolution of the obtained information; a type of the obtained information includes an information source; the at least one processor is configured to cause the first apparatus to report, to a network entity, a status of the computational artificial intelligence machine learning model.

Additionally, the NE 1400 may be configured to support any one or combination of where the status includes one or more of, based at least in part on application of the computational artificial intelligence machine learning model, an accuracy of the passive sensing measurement, an error level of the passive sensing measurement, or a request for retraining of the computational artificial intelligence machine learning model; the function to be computed includes one or more of: a filtering applied on the first signal; a filtering applied on the second signal; one or more of a power measurement or an energy measurement of at least one of the first signal or a filtered first signal; one or more of a power measurement or an energy measurement of at least one of the second signal or a filtered second signal; cross-correlation computation at indicated one or multiple delay taps between at least one of the first signal or a filtered first signal, and at least one of the second signal or a filtered second signal; or harmonics by which a signal received from the reference beam is one or more of mixed or multiplied to generate the second signal received via the sensing beam; receive a suitability query including suitability criteria for performing the passive sensing measurement.

Additionally, the NE 1400 may be configured to support any one or combination of the suitability criteria including one or more of: a location area for passive sensing measurement; one or more of a line of sight condition toward a transmission point or a line of sight condition for reception of a configured sensing signal with an indicated probability; or a capability of passive sensing measurement for one or more of an indicated measurement type or an indicated measurement accuracy; and transmit a response to the received suitability criteria; the at least one processor is configured to cause the first apparatus to receive the suitability query via one or more of a broadcast message, a multicast message, dedicated signaling in a connected state, a paging message with a group RNTI associated with sensing, or a paging RNTI with a first apparatus identity in the paging message and the suitability criteria as part of the paging message; the capability of passive sensing measurement for the indicated measurement type includes one or more of Layer 1 reference signal received power (L1-RSRP), angle measurements, time, delay or delay difference, cross correlation, or harmonic analysis; receive a first set of one or more downlink beams including a suitability query for performing the passive sensing measurement; and receive a second set of one or more downlink beams for performing the passive sensing measurement.

The NE 1400 may be configured to or operable to support a means for receiving a request for a sensing task associated with an area of interest for sensing; transmitting, to a second apparatus, a message including a suitability query for a passive sensing measurement of the area of interest for sensing; receiving a response including a suitability indication for performing passive sensing measurements of the area of interest for sensing; and transmitting, to the second apparatus, measurement configuration for performing passive sensing measurements of the area of interest.

Additionally, the NE 1400 may be configured to support any one or combination of receiving reports of the passive sensing measurements from the second apparatus; computing the sensing results associated to the received sensing tasks; and transmitting the obtained sensing results to the requester of the sensing task; the first apparatus includes a network entity and the second apparatus includes a user equipment (UE); the first apparatus includes a first user equipment (UE) and the second apparatus includes a second UE; determining information including at least one of one or more transmissions of physical data, one or more transmissions of control signals, or one or more transmissions of reference signals illuminating the area of interest for sensing; determining the information via communication with a RAN node and via sensing a query and response toward a gNB assigned for a sensing task; transmitting the message including the suitability query via one or more of a broadcast message or a groupcast message; the suitability query includes one or more of: passive sensing configuration; a capability description for a passive sensing user equipment (UE); a maximum distance to the area of interest for sensing; an accuracy value for a passive sensing measurement; or an availability indication for a line of sight condition at the second apparatus; transmitting a first set of one or more downlink beams including the suitability query; and transmitting a second set of one or more downlink beams for performing the passive sensing measurement.

Additionally, or alternatively, the NE 1400 may support to receive a request for a sensing task associated with an area of interest for sensing; transmit, to a second apparatus, a message including a suitability query for a passive sensing measurement of the area of interest for sensing; receive a response including a suitability indication for performing passive sensing measurements of the area of interest for sensing; and transmit, to the second apparatus, measurement configuration for performing passive sensing measurements of the area of interest.

Additionally, the NE 1400 may be configured to support any one or combination of to receive reports of the passive sensing measurements from the second apparatus; compute sensing results associated to the received sensing tasks; and transmit the sensing results to the requester of the sensing task; the first apparatus includes a network entity and the second apparatus includes a user equipment (first apparatus); the first apparatus includes a first user equipment (first apparatus) and the second apparatus includes a second first apparatus; the at least one processor is configured to cause the first apparatus determine information including at least one of one or more transmissions of physical data, one or more transmissions of control signals, or one or more transmissions of reference signals illuminating the area of interest for sensing; the at least one processor is configured to cause the first apparatus to determine the information via communication with a RAN node and via sensing a query and response toward a gNB assigned for a sensing task; the at least one processor is configured to cause the first apparatus to transmit the message including the suitability query via one or more of a broadcast message or a groupcast message; the suitability query includes one or more of: passive sensing configuration; a capability description for a passive sensing user equipment (first apparatus); a maximum distance to the area of interest for sensing; an accuracy value for a passive sensing measurement; or an availability indication for a line of sight condition at the second apparatus; transmit a first set of one or more downlink beams including the suitability query; and transmit a second set of one or more downlink beams for performing the passive sensing measurement.

The NE 1400 may be configured to or operable to support a means for transmitting measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receiving a passive sensing measurement based at least in part on the received measurement configuration.

Additionally, the NE 1400 may be configured to support any one or combination of transmitting the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmitting a query to the RAN node; and receiving a response from the RAN node indicating one or more of the first availability information or the second availability information; requesting that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level.

Additionally, the NE 1400 may be configured to support any one or combination of where an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space; the indication that the transmission direction of the signal transmission is aligned includes one or more of an angular azimuth or an elevation difference; transmitting a request for additional information for one or more signal transmission parameters; and transmitting a request message for transmission of a message decodable via a RNTI which is sharable with one or more user equipment (UE) capable of performing sensing measurements, the request message including one or more of suitability criteria or description of UE for performing a passive sensing measurement; the request for additional information includes a request for one or more of more accurate time resources or more accurate frequency resources for signal transmission.

Additionally, or alternatively, the NE 1400 may support to transmit measurement configuration for performing a passive sensing measurement, the measurement configuration including: one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the sensing signal, and the second signal obtained from application of the sensing beam to the sensing signal; and receive a passive sensing measurement based at least in part on the received measurement configuration.

Additionally, the NE 1400 may be configured to support any one or combination of where the at least one processor is configured to cause the first apparatus to transmit the measurement configuration based on at least one of: first availability information indicating one or more of a communication link or a signal transmission from a RAN node that is illuminating a same area as a specified area for sensing; or second availability information indicating one or more of a communication link or a signal transmission from the RAN node that is transmitted at one or more of approximately a same azimuth or approximately a same elevation angle as the specified area for sensing; transmit a query to the RAN node; and receive a response from the RAN node indicating one or more of the first availability information or the second availability information; the at least one processor is configured to cause the first apparatus to request that one or more RAN nodes transmit, to the first apparatus, one or more signal transmissions that satisfy one or more signal criteria, the one or more signal criteria including at least one of: an indication that signal transmission by the one or more RAN nodes illuminates at least a subset of an area of interest for sensing with an indicated minimum energy level.

Additionally, the NE 1400 may be configured to support any one or combination of where an indication that a transmission direction of a signal transmission is aligned with a direction of the area of interest for sensing; an indication that a transmission point of a signal transmission is within an indicated distance of the area of interest for sensing; or an indication that signal transmission persists for one or more of a minimum indicated time duration or a minimum indicated frequency domain space; the indication that the transmission direction of the signal transmission is aligned includes one or more of an angular azimuth or an elevation difference; transmit a request for additional information for one or more signal transmission parameters; and transmit a request message for transmission of a message decodable via a RNTI which is sharable with one or more user equipment (first apparatus) capable of performing sensing measurements, the request message including one or more of suitability criteria or description of first apparatus for performing a passive sensing measurement; the request for additional information includes a request for one or more of more accurate time resources or more accurate frequency resources for signal transmission.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

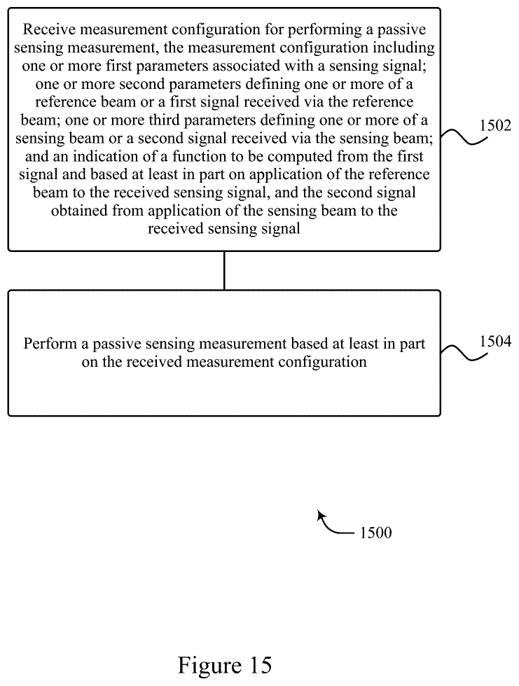

FIG. 15 illustrates a flowchart of a method 1500 in accordance with aspects of the present disclosure. The operations of the method may be implemented by a UE 104, a processor 1300, and/or a NE 102 as described herein. In some implementations, the UE, NE, and/or processor may execute a set of instructions to control the function elements of UE, NE, and/or processor to perform the described functions. It should be noted that the method described herein describes a possible implementation, and that the operations and the steps may be rearranged or otherwise modified and that other implementations are possible.

At 1502, the method may include receiving measurement configuration for performing a passive sensing measurement, the measurement configuration including one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal. The operations of 1502 may be performed in accordance with examples as described herein. In some implementations, aspects of the operations of 1502 may be performed by a UE as described with reference to FIG. 12, a processor as described with reference to FIG. 13, and/or a NE 1400 as described with reference to FIG. 14.

At 1504, the method may include performing a passive sensing measurement based at least in part on the received measurement configuration. The operations of 1504 may be performed in accordance with examples as described herein. In some implementations, aspects of the operations of 1504 may be performed by a UE as described with reference to FIG. 12, a processor as described with reference to FIG. 13, and/or a NE 1400 as described with reference to FIG. 14.

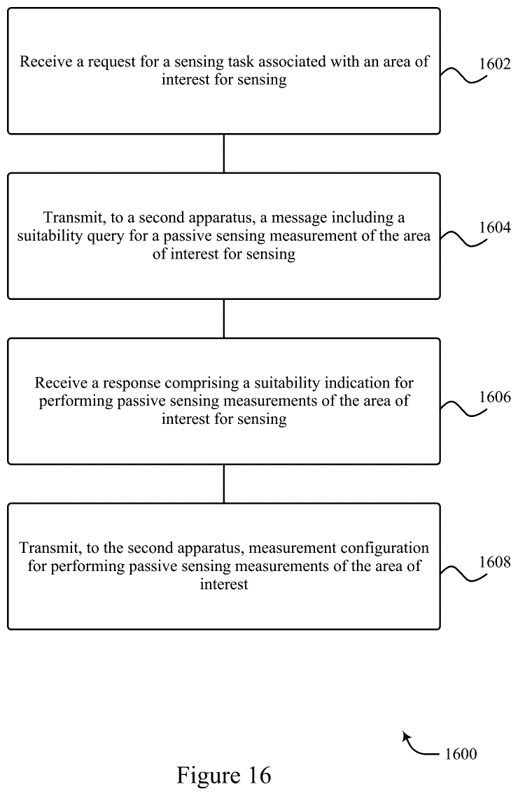

FIG. 16 illustrates a flowchart of a method 1600 in accordance with aspects of the present disclosure. The operations of the method may be implemented by a UE 104, a processor 1300, and/or a NE 102 as described herein. In some implementations, the UE, NE, and/or processor may execute a set of instructions to control the function elements of UE, NE, and/or processor to perform the described functions. It should be noted that the method described herein describes a possible implementation, and that the operations and the steps may be rearranged or otherwise modified and that other implementations are possible.

At 1602, the method may include receiving a request for a sensing task associated with an area of interest for sensing. The operations of 1602 may be performed in accordance with examples as described herein. In some implementations, aspects of the operations of 1602 may be performed by a UE as described with reference to FIG. 12, a processor as described with reference to FIG. 13, and/or a NE 1400 as described with reference to FIG. 14.

At 1604, the method may include transmitting, to a second apparatus, a message including a suitability query for a passive sensing measurement of the area of interest for sensing. The operations of 1604 may be performed in accordance with examples as described herein. In some implementations, aspects of the operations of 1604 may be performed by a UE as described with reference to FIG. 12, a processor as described with reference to FIG. 13, and/or a NE 1400 as described with reference to FIG. 14.

At 1606, the method may include receiving response comprising a suitability indication for performing passive sensing measurements of the area of interest for sensing. The operations of 1606 may be performed in accordance with examples as described herein. In some implementations, aspects of the operations of 1606 may be performed by a UE as described with reference to FIG. 12, a processor as described with reference to FIG. 13, and/or a NE 1400 as described with reference to FIG. 14.

At 1608, the method may include transmitting, to the second apparatus, measurement configuration for performing passive sensing measurements of the area of interest. The operations of 1608 may be performed in accordance with examples as described herein. In some implementations, aspects of the operations of 1608 may be performed by a UE as described with reference to FIG. 12, a processor as described with reference to FIG. 13, and/or a NE 1400 as described with reference to FIG. 14.

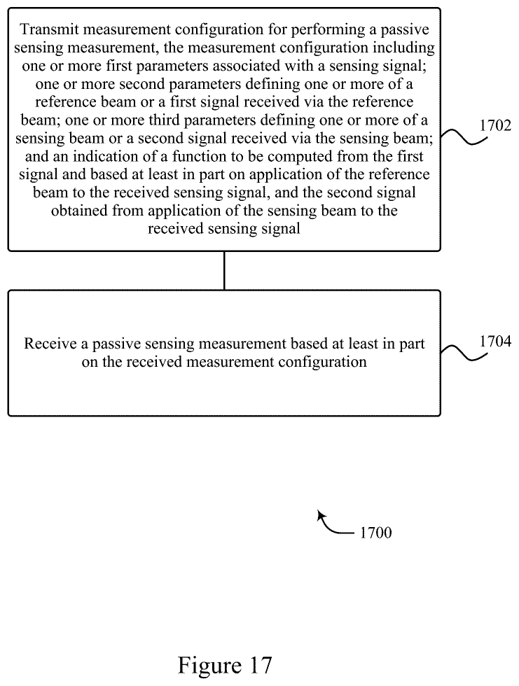

FIG. 17 illustrates a flowchart of a method 1700 in accordance with aspects of the present disclosure. The operations of the method may be implemented by a UE 104, a processor 1300, and/or a NE 102 as described herein. In some implementations, the UE, NE, and/or processor may execute a set of instructions to control the function elements of UE, NE, and/or processor to perform the described functions. It should be noted that the method described herein describes a possible implementation, and that the operations and the steps may be rearranged or otherwise modified and that other implementations are possible.

At 1702, the method may include transmitting measurement configuration for performing a passive sensing measurement, the measurement configuration including one or more first parameters associated with a sensing signal; one or more second parameters defining one or more of a reference beam or a first signal received via the reference beam; one or more third parameters defining one or more of a sensing beam or a second signal received via the sensing beam; and an indication of a function to be computed from the first signal and based at least in part on application of the reference beam to the received sensing signal, and the second signal obtained from application of the sensing beam to the received sensing signal. The operations of 1702 may be performed in accordance with examples as described herein. In some implementations, aspects of the operations of 1702 may be performed by a UE as described with reference to FIG. 12, a processor as described with reference to FIG. 13, and/or a NE 1400 as described with reference to FIG. 14.

At 1704, the method may include receiving a passive sensing measurement based at least in part on the received measurement configuration. The operations of 1704 may be performed in accordance with examples as described herein. In some implementations, aspects of the operations of 1704 may be performed by a UE as described with reference to FIG. 12, a processor as described with reference to FIG. 13, and/or a NE 1400 as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first apparatus for wireless communication, comprising:
at least one memory; and
at least one processor coupled with the at least one memory and configured to cause the first apparatus to:
receive measurement configuration for performing a passive sensing measurement, the measurement configuration comprising:
one or more first parameters associated with a sensing signal, the one or more first parameters comprising one or more of communication channel resources (e.g., time resources or frequency resources or code resources) of the sensing signal;
one or more second parameters defining one or more of a reference beam or a first signal received via the reference beam;
one or more third parameters defining one or more of a sensing beam or a second signal received via the sensing beam; and
an indication of a function to be computed from the first signal and based at least in part on application of the reference beam to the sensing signal, and the second signal obtained from application of the sensing beam to the sensing signal; and
perform a passive sensing measurement based at least in part on the received measurement configuration.

2. The first apparatus of claim 1, wherein the sensing signal is indicated to illuminate a sensing target area of interest.

3. The first apparatus of claim 1, wherein the at least one processor is configured to cause the first apparatus to:
receive reporting configuration for reporting the passive sensing measurement; and
transmit a report of the passive sensing measurement and according to the reporting configuration.

4. The first apparatus of claim 1, wherein at least one of the one or more second parameters or the one or more third parameters comprise one or more of:
at least one of an indication of one or more propagation paths of a wireless channel that are one or more of received by the first apparatus or transmitted by the first apparatus, the at least one indication of the one or more propagation paths comprising one or more of a path, a path identifier, a path description, a previously detected path, a previously reported path, or a previously tracked path;
at least one of an object indicated to the first apparatus via an object ID, wherein the object is one or more of previously defined for the first apparatus detected, reported by the first apparatus, tracked by the first apparatus, or measured by the first apparatus;
at least one of an indication of a quasi-co-location (QCL) type-D relation, a transmit beam identifier, or a receive beam identifier of the first apparatus among the one or more propagation paths; or
relative to one or more of an antenna or an antenna array of the first apparatus, at least one of an indication of a beam angular description, an illumination area description, an angle, an area index, a relative angle, or a relative area index.

5. The first apparatus of claim 4, wherein the path description comprises one or more values for one or more of azimuth, elevation of arrival, elevation of departure, propagation path delay, or doppler shift.

6. The first apparatus of claim 4, wherein the object is indicated to the first apparatus by indicating one or more of object type, object radar cross section (RCS), object position, object area, or object velocity.

7. The first apparatus of claim 4, wherein measurements by the first apparatus comprise one or more of measurements of path power, delay, angle, or doppler shift associated to the first apparatus.

8. The first apparatus of claim 1, wherein the at least one processor is configured to cause the first apparatus to determine the sensing beam based at least in part on one or more of information available at the first apparatus or information that can be obtained by the first apparatus within an indicated time delay.

9. The first apparatus of claim 8, wherein the at least one processor is configured to cause the first apparatus to indicate, to a network, availability of the information at the first apparatus or capability of the first apparatus to obtain the information.

10. The first apparatus of claim 8, wherein the information available at the first apparatus comprises one or more of pose information, heading of the first apparatus, movement direction of the first apparatus, a direction, or area of interest for sensing determined by a first apparatus application.

11. The first apparatus of claim 1, wherein the measurement configuration further comprises one or more sensing signal descriptions including a transmission description, the transmission description comprising one or more of a transmit point, a transmit power, an angle of arrival, an angle of departure, a zenith of arrival, a zenith of departure, one or more transmission time resources, one or more transmission frequency resources, transmission beam angular pattern, illumination power, energy density in one or more of time or surface of an area of interest for sensing.

12. The first apparatus of claim 11, wherein the at least one processor is configured to cause the first apparatus to:
one or more of determine or transmit a preference of one or more of the sensing signal descriptions for performing passive sensing measurements; and
perform, based at least in part on the preference of the one or more of the sensing signal descriptions, the passive sensing measurements based at least in part on reception of a transmission as a preferred signal.

13. The first apparatus of claim 1, wherein indication of the function to be computed comprises an indication of a computational artificial intelligence machine learning model.

14. The first apparatus of claim 13, wherein the indication of the computational artificial intelligence machine learning model is indicated via an index from a codebook of known computational artificial intelligence machine learning models for performing passive sensing measurements by the first apparatus.

15. The first apparatus of claim 14, wherein the known computational artificial intelligence machine learning models comprise one or more of:
one or more artificial intelligence machine learning models transferred to the first apparatus for sensing measurements; or
one or more artificial intelligence machine learning models available at the first apparatus and indicated by the first apparatus to a sensing configuration entity for the passive sensing measurements.

16. The first apparatus of claim 13, wherein the at least one processor is configured to cause the first apparatus to:
receive an artificial intelligence machine learning model training configuration, wherein the training configuration comprises one or more of a description of a sensing signal transmitted from a transmission point, the description of the sensing signal comprising at least one of one or more time resources for transmission, one or more frequency resources for transmission, a transmission power, a transmission energy, a transmission point, an angular description of a transmission beam, or an illumination pattern of a sensing target area;
receive first state information on a state of one or more objects;
receive the sensing signal according to the received training configuration; and
perform training of the computational artificial intelligence machine learning model based at least in part on the received sensing signal and the received training configuration.

17. The first apparatus of claim 16, wherein the information on the state of the one or more objects comprises one or more of presence information for the one or more objects, position information for the one or more objects, speed information for the one or more objects, object radar cross section (RCS), object shape, object size, object dimensions, object velocity, direction of object movement, a blockage state of a path, or a blockage state of a path associated with one or more of an angle or a zenith or arrival towards the first apparatus.

18. A first apparatus for wireless communication, comprising:
at least one memory; and
at least one processor coupled with the at least one memory and configured to cause the first apparatus to:
receive a request for a sensing task associated with an area of interest for sensing;
transmit, to a second apparatus, a message including a suitability query for a passive sensing measurement of the area of interest for sensing;
receive a response comprising a suitability indication for performing passive sensing measurements of the area of interest for sensing; and
transmit, to the second apparatus, measurement configuration for performing passive sensing measurements of the area of interest.

19. A first apparatus for wireless communication, comprising:
at least one memory; and
at least one processor coupled with the at least one memory and configured to cause the first apparatus to:
transmit measurement configuration for performing a passive sensing measurement, the measurement configuration comprising:
one or more first parameters associated with a sensing signal;
one or more second parameters defining one or more of a reference beam or a first signal received via the reference beam;
one or more third parameters defining one or more of a sensing beam or a second signal received via the sensing beam; and
an indication of a function to be computed from the first signal and based at least in part on application of the reference beam to the sensing signal, and the second signal obtained from application of the sensing beam to the sensing signal; and
receive a passive sensing measurement based at least in part on the received measurement configuration.

20. A processor for wireless communication, comprising:
at least one controller coupled with at least one memory and configured to cause the processor to:
receive measurement configuration for performing a passive sensing measurement, the measurement configuration comprising:
one or more first parameters associated with a sensing signal, the one or more first parameters comprising one or more of communication channel resources (e.g., time resources or frequency resources or code resources) of the sensing signal;
one or more second parameters defining one or more of a reference beam or a first signal received via the reference beam;
one or more third parameters defining one or more of a sensing beam or a second signal received via the sensing beam; and
an indication of a function to be computed from the first signal and based at least in part on application of the reference beam to the received sensing signal, and the second signal obtained from application of the sensing beam to the received sensing signal; and
perform a passive sensing measurement based at least in part on the received measurement configuration.
